(19) United States
(12) Patent Application Publication
(10) Pub. No.: US 2016/0136553 A1
(43) Pub. Date: May 19, 2016

(54) RESIN IMPREGNATED FIBER WEBS

(71) Applicant: Hollingsworth & Vose Company, East Walpole, MA (US)

(72) Inventors: David T. Healey, Bellingham, MA (US); Sneha Swaminathan, Merrimack, NH (US)

(73) Assignee: Hollingsworth & Vose Company, East Walpole, MA (US)

(21) Appl. No.: 14/547,276

(22) Filed: Nov. 19, 2014

(51) Int. Cl. B01D 39/16; B01D 39/14

(52) U.S. Cl. CPC B01D 39/163; B01D 39/14

(57) ABSTRACT

The present disclosure relates to filter media having one or more pre-filter layers disposed upstream a main filtration layer. The main filtration layer may include synthetic polymer fibers (e.g., continuous meltblown fibers). A coating (e.g., binder resin) may be suitably applied to at least a portion of the main filtration layer (e.g., saturated, impregnated) and/or other layers of the filter media (e.g., pre-filter layer(s), scrim, etc.), or portions thereof. In some embodiments, the coating has a cure temperature that is comparatively less than a shrinkage temperature of the synthetic polymer fibers of the filtration layer(s). In some embodiments, the coating may coat a 5 cm×5 cm area, or a majority area, of the outer surface of the second layer. In some embodiments, the second layer has a pressure drop of less than about 80 kPa, a mean flow pore size of between about 0.05 micron and about 30 microns with the standard deviation of the mean flow pore size of the second layer being less than about 10 microns.

### FIELD

The present embodiments relate generally to fiber webs, and specifically, to fiber webs that are coated with a resin.

### BACKGROUND

Filter elements can be used to remove contamination in a variety of applications. Such elements can include a filter media which may be formed of a web of fibers. The fiber web provides a porous structure that permits fluid (e.g., gas, liquid) to flow through the media. Contaminant particles (e.g., dust particles, soot particles) contained within the fluid may be trapped on or in the fiber web. Depending on the application, the filter media may be designed to have different performance characteristics.

In some applications, fiber webs may be coated with a resin. Although many coated fiber webs exist, improvements in the mechanical properties of the fiber web (e.g., stiffness, strength, and elongation) would be beneficial.

### SUMMARY

Fiber webs that are coated with a resin, and related components, systems, and methods associated therewith are provided. The subject matter of this application involves, in some cases, interrelated products, alternative solutions to a particular problem, and/or a plurality of different uses of structures and compositions.

In an illustrative embodiment, a filter media is provided. The filter media may include a first layer including fibers having a first average diameter of between about 0.3 microns and about 40.0 microns; a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and a resin coating that coats a majority of an outer surface of the second layer, wherein the filter media has an air permeability of between about 0.5 cfm/sf and about 500 cfm/sf, a basis weight of between about 1 g/m² and about 600 g/m² and a thickness of between about 1 mils and about 300 mils.

In another illustrative embodiment, a filter media is provided. The filter media may include a first layer including fibers having a first average diameter of between about 0.3 microns and about 40.0 microns; a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and a resin coating that coats at least a 5 cm×5 cm area of an outer surface of the second layer, wherein the filter media has an air permeability of between about 0.5 cfm/sf and about 500 cfm/sf, a basis weight of between about 1 g/m² and about 600 g/m² and a thickness of between about 1 mils and about 300 mils.

In yet another illustrative embodiment, a filter media is provided. The filter media may include a first layer including fibers having a first average diameter of between about 0.3 microns and about 40.0 microns; a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and a resin coating that coats at least a portion of the second layer, the coating having a cure temperature that is less than a shrinkage temperature of the synthetic polymer fibers, wherein the filter media has an air permeability of between about 0.5 cfm/sf and about 500 cfm/sf, a basis weight of between about 1 g/m² and about 600 g/m² and a thickness of between about 1 mil and about 300 mils.

In a further illustrative embodiment, a filter media is provided. The filter media may include a first layer including fibers having a first average diameter of between about 0.3 microns and about 40.0 microns; a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and a resin coating that coats at least a portion of the second layer, the second layer having a pressure drop of less than about 80 kPa, the second layer having a mean flow pore size of between about 0.05 microns and about 30 microns, and the standard deviation of the mean flow pore size of the second layer being less than about 10 microns, wherein the filter media has an air permeability of between about 0.5 cfm/sf and about 500 cfm/sf, a basis weight of between about 1 g/m² and about 600 g/m² and a thickness of between about 1 mils and about 300 mils.

Other aspects, embodiments, advantages and features of the invention will become apparent from the following detailed description.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the various embodiments. In the figures:

FIG. 1 shows an example of a filter media having multiple layers according to one set of embodiments;

FIG. 2 shows an example of a filter media having multiple layers according to one set of embodiments;

FIG. 3A is a schematic diagram showing a cross section of a fiber web including a plurality of fibers according to one set of embodiments;

FIG. 3B is a schematic diagram showing a cross section of a fiber web including fibers that are partially coated with a resin according to one set of embodiments;

FIG. 3C is a schematic diagram showing a cross section of a fiber web in which substantially all of the fibers are coated with a resin according to one set of embodiments; and

FIGS. 4A-4B show examples of filter elements according to some embodiments.

### DETAILED DESCRIPTION

Embodiments described herein relate to a filter media having multiple layers where the layers are made to perform various functions. For instance, the filter media may include one or more pre-filter layers and one or more main filtration layers. In general, during use, the pre-filter layer(s) are located upstream of the main filtration layer(s).

As discussed in greater detail further below, each of the pre-filter layer(s) and the main filtration layer(s) may include a variety of suitable compositions. For instance, the pre-filter layer(s) may include glass fibers (e.g., microglass, chopped strand), cellulose fibers (e.g., regenerated cellulose such as lyocell), meltblown fibers, other synthetic fibers, etc. In some embodiments, the main filtration layer(s) includes synthetic polymer fibers (e.g., meltblown fibers). In some embodiments, the filter media includes a non-woven fiber web. In other embodiments, the filter media may include a woven fiber web. Generally, fibers in a non-woven web are randomly entangled together, whereas fibers in a woven web are woven together and ordered.

In various embodiments, a coating (e.g., binder resin) is at least partially applied to the main filtration layer(s). The coating may be saturated or otherwise impregnated throughout the main filtration layer(s) and/or may be applied to an outer surface of the main filtration layer(s), though, the coating may also be suitably applied to other layers as well. For example, the coating may be applied so as to substantially impregnate the main filtration layer(s), scrim and/or pre-filter layer(s) of the filter media.

In certain embodiments in which the main filtration layer(s) comprises synthetic polymer fibers, the coating has a cure temperature that is less than a shrinkage temperature of the synthetic polymer fibers of the main filtration layer(s). For example, the cure temperature of the coating may be greater than or equal to about 5% less than the shrinkage temperature of the synthetic polymer fibers of the main filtration layer(s). As used herein, when determining the shrinkage temperature of synthetic polymer fibers, a fiber web of the synthetic polymer fibers having an initial area of 8.5 inches in length by 8.5 inches in width is first provided. The temperature of the surrounding environment of the fiber web is increased starting at room temperature by 1 degree C. increments, at 1 minute intervals, while at otherwise ambient conditions (approximately 1 atmosphere of pressure). At each 1 minute interval, the length and width of the fiber web are measured, so as to calculate the area of the fiber web. The shrinkage temperature is determined when the reduction in area of the fiber web as compared to the initial area of the fiber web, prior to beginning of the incremental temperature increase (an area of 8.5 inches×8.5 inches), is greater than or equal to 5%.

In some instances, addition of the coating to the main filtration layer(s) may provide the main filtration layer(s) with enhanced mechanical support or strength, which can be helpful in maintaining the size and structure of the pores in the layer(s). For example, a main filtration layer may have relatively small pores (e.g., in comparison to the pores of the pre-filter, which generally has a more open structure). Such small pores may have a tendency to become smaller or even closed (e.g., collapse) when subject to mechanical compression or other agitation. Such size reduction of the pores of the main filtration layer may lead to clogging and/or an undesirable decrease in permeability therethrough, hence, an increase in pressure drop. Though, when suitably applied to the main filtration layer, as discussed herein, the coating may provide the pores with added mechanical support so as to substantially maintain their size and structure. As a result, with use, the main filtration layer, and thus the overall filter media, may retain a desirable level of permeability as well as relatively low pressure drop.

In some embodiments, at least a portion (e.g., coated portion) of the main filtration layer(s), or the entirety of the main filtration layer(s), of the filter media may have a mean flow pore size that falls within a suitable range (e.g., between about 0.05 microns and about 30 microns), having a relatively tight distribution, such as a standard deviation that is less than about 10 microns. For example, the portion of the main filtration layer(s) (e.g., coated portion) that has a suitable standard deviation (e.g., less than about 10 microns, less than about 8 microns) may include a majority of the area of the outer surface (e.g., over at least a 5 cm×5 cm area) of the main filtration layer(s). As described further below, certain filter media described herein may have desirable properties including high dust holding capacity, high efficiency (e.g., a low micron rating for beta efficiency), and low resistance to fluid flow. The media may be incorporated into a variety of filter element products including hydraulic filters, fuel filters, lube filters, or other suitable filter element products.

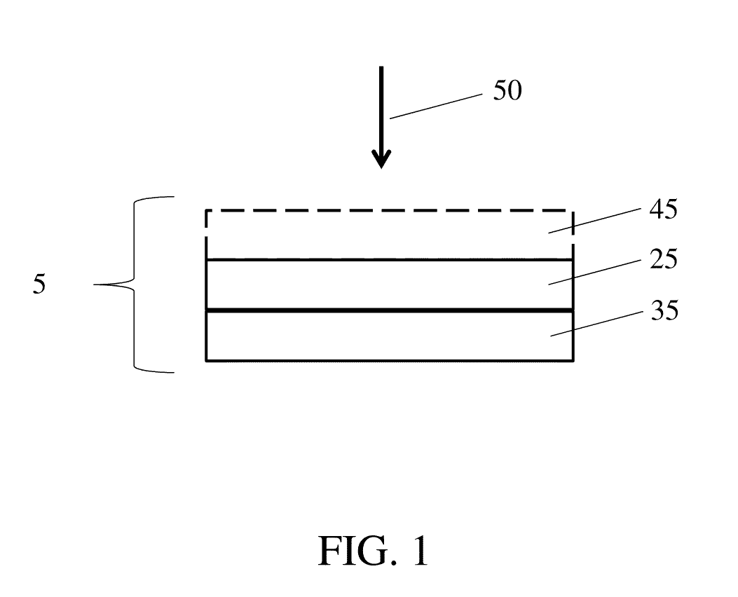

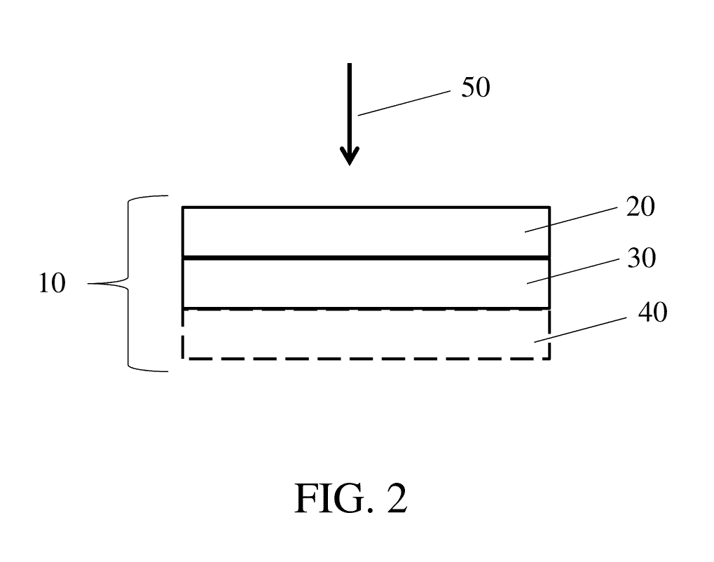

Non-limiting examples of filter media described herein are shown illustratively in FIGS. 1 and 2. As shown in the embodiment illustrated in FIG. 1, a filter media 5 includes a first layer 25 adjacent a second layer 35. In some embodiments, the first layer 25 is a pre-filter layer and the second layer 35 is a main filtration layer. The first layer may be positioned upstream compared to the second layer, e.g., in a filter element. Optionally, the filter media 5 can include a third layer 45 adjacent the first layer. Here, the third layer 45 may be an additional pre-filter layer, and may be positioned upstream relative to the first and second layers.

As used herein, when a layer is referred to as being “adjacent” another layer, it can be directly adjacent the layer, or an intervening layer also may be present. A layer that is “directly adjacent” or “in contact with” another layer means that no intervening layer is present.

In some embodiments, as illustrated in FIG. 2, a filter media 10 includes a first layer 20 adjacent a second layer 30 and optionally, a third layer 40 adjacent the second layer. In some embodiments, the first layer 20 is a pre-filter layer and the second layer 30 is a main filtration layer. The third layer 40 may be a scrim or other support structure for the filter media. Additional layers, e.g., fourth, fifth, or sixth layers (e.g., up to 10 or more layers), may also be included in some cases. The orientation of filter media 5 or 10 relative to fluid flow through the media can generally be selected as desired. As shown illustratively in FIGS. 1 and 2, the first layer is upstream of the second layer in the direction of fluid flow, as indicated by arrow 50.

In some cases, each of the layers of the filter media has different characteristics and filtration properties that, when combined, result in desirable overall filtration performance, for example, as compared to a filter media having a single-layer structure. For example, in one set of embodiments, as noted above, the first layer (e.g., layer 20, layer 25) is a pre-filter layer (also known as a “loading layer”) and the second layer (e.g., layer 30, layer 35) is a main filtration layer (also known as an “efficiency layer”).

Generally, a pre-filter layer is formed using coarser fibers, with a relatively open pore structure, and therefore has a lower resistance to fluid flow, than that of a main filtration layer. The main filtration layer may include relatively finer fibers, with a relatively tight pore structure, and may generally have a higher resistance to fluid flow and/or a smaller mean flow pore size than that of a pre-filter layer. As such, a main filtration layer can generally trap particles of smaller size in comparison to the pre-filter layer. In one example, filter media 5 of FIG. 1 includes one or more pre-filter layers (e.g., layers 25 and/or 45) and a main filtration layer (e.g., layer 35) comprising fibers having a relatively small diameter on average (e.g., less than or equal to about 5 microns, less than or equal to about 4 microns, less than or equal to about 3 microns, less than or equal to about 2 microns, less than or equal to about 1.5 microns, or less than or equal to about 1 micron).

In some embodiments, the main filtration layer may be formed of fibers having a smaller average fiber diameter than that of the one or more pre-filter layers. The main filtration layer (e.g., layer 35) may include fibers other than glass fibers. For example, the main filtration layer may include meltblown fibers, meltspun fibers, melt electrospun fibers, solvent electrospun fibers, centrifugal spun fibers, synthetic staple fibers and/or a combination thereof. The main filtration layer may be formed via a wet laid, air laid, carded, meltblown, meltspinng, meltelectrospinning, solvent electrospinning, or centrifugal spinning process. In some embodiments, the main filtration layer may be formed of substantially continuous meltblown fibers.

In some embodiments, where a third layer is present, e.g., as illustrated in FIG. 1, the third layer may be an additional pre-filter layer that has similar or different properties as first layer 25. For example, the third layer may have even coarser fibers and a lower resistance to fluid flow than that of first layer 25. In other embodiments, where third layer 40 is present as illustrated in FIG. 2, the third layer may be an additional main filtration layer that has the same or different properties as second layer 30. For example, the third layer may have even finer fibers and a higher resistance to fluid flow than that of second layer 30. Or, the third layer may be provided as a support structure, such as a scrim.

The filter media can also have other configurations of first, second, and optionally third or more layers. For instance, in some cases, the filter media 10 includes only a single pre-filter layer, and a single main filtration layer (optionally formed on and/or positioned on a scrim).

In some embodiments, a layer having relatively coarse fibers may be positioned between two layers having relatively finer fibers. Other configurations are also possible. Additionally, a filter media may include any suitable number of layers, e.g., at least 2, 3, 4, 5, 6, 7, 8, or 9 layers (e.g., up to 10 layers), depending on the particular application and performance characteristics desired.

As noted above, each of the layers of the filter media can have different properties. For instance, the first and second layers can include fibers having different characteristics (e.g., fiber diameters, fiber compositions, and/or fiber lengths). Fibers with different characteristics can be made from one material (e.g., by using different process conditions) or different materials (e.g., glass fibers, synthetic fibers, cellulose fibers, and combinations thereof). In some embodiments, it is believed that a filter media having a multilayered structure with layers including different characteristics may exhibit significantly improved performance properties such as dust holding capacity, pressure drop, efficiency and/or other properties compared to a filter media having a single-layered structure.

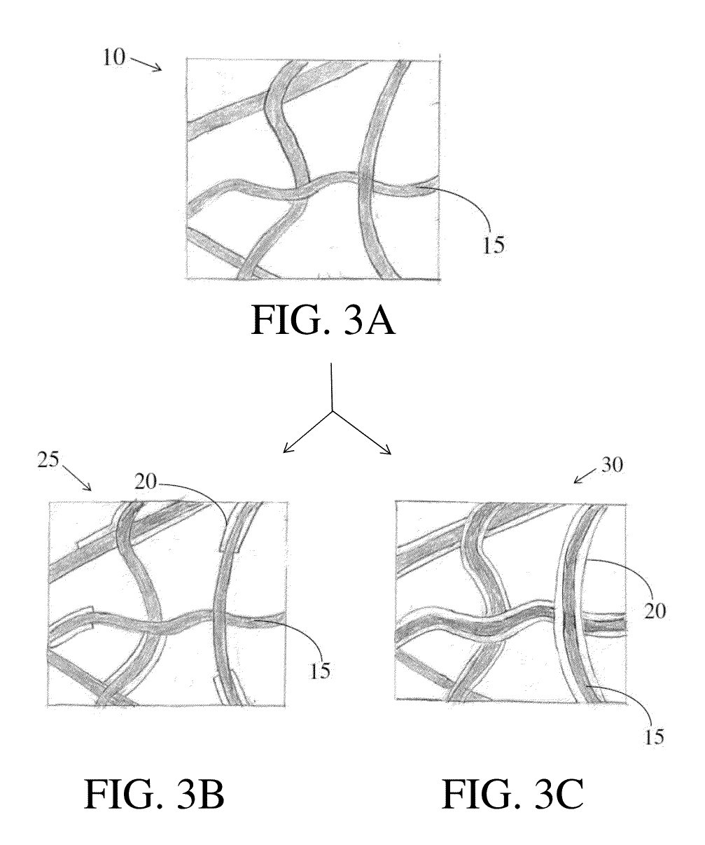

As described herein, in some embodiments, at least a portion of a fiber web incorporated within a filter media is coated (e.g., saturated, impregnated, applied on an exterior surface) with a resin (e.g., binder resin). An example of a fiber web that is coated with a resin is shown in FIGS. 3A-3C. As shown illustratively in FIG. 3A, a fiber web 10, shown in cross-section, may include a plurality of fibers 15. In some embodiments, all or portions of the fiber web may be coated with a resin including one or more components, or at least two components (e.g., a first component and a second component), as illustrated in FIGS. 3B-3C. After coating the fiber web with the resin and removing excess resin from the fiber web, the resin may be cured. For instance, in some embodiments, a component in the resin may undergo a chemical reaction with itself and/or another component to form a reaction product (e.g., a copolymer, a crosslinked network, a cured network). In certain embodiments, at least two components of the resin may react with one another to form a copolymer, as described in more detail below. Alternatively, the resin includes a single component.

The extent of the coating may vary. For example, in one embodiment, a coating may be formed on a surface of the fiber web. In some embodiments, a resin may be applied to the fiber web to produce a coating on at least a portion of the fibers in the interior of the fiber web (i.e., through the thickness of the fiber web). In certain embodiments, substantially all of the fibers of the fiber web may be coated with the resin, as illustrated in FIG. 3C. However, in some embodiments, not all fibers are coated, e.g., as illustrated in FIG. 3B. In some embodiments, the coated fiber webs 25 and 30, shown in FIGS. 3B and 3C, respectively, may be used as filter media and may have enhanced mechanical properties as described herein. A number of possible coatings that may be applied to the main filtration layer are described below and, in some embodiments, may be applicable to the pre-filter, or other parts of the filter media.

Various aspects of a pre-filter of the filter media will now be described. In some embodiments, a pre-filter of a filter media may have one or more layers.

In some such embodiments, the pre-filter layer(s) may be wet laid or non-wet laid (e.g., formed of a non-wet laid process such as carding, meltblown, meltspinning, centrifugal spinning, electrospinning, spunbond, or air laid process). In some embodiments, the pre-filter layer(s) include fibers formed of a synthetic polymer. Additionally or alternatively, a pre-filter layer may include glass fibers as described herein, cellulose fibers, synthetic fibers (e.g., meltblown fibers), or a combination thereof. In various embodiments, a pre-filter layer includes a carded web. In some embodiments, the pre-filter may include a carded web and other layers (e.g., glass fiber layers, meltblown fiber layers) disposed adjacent (e.g., downstream) to the carded web. It should be understood that the filter media may comprise any suitable number of pre-filter layers (e.g., at least 1, at least 2, at least 3, at least 4, at least 6, at least 8, at least 10 layers).

In certain embodiments, one or more layers of a pre-filter may have an average fiber diameter of between about 0.1 to about 40 microns, a basis weight of between about 5 gsm to about 450 gsm, a mean flow pore size of between about 4 microns to about 100 microns, between about 5 microns to about 90 microns or between about 10 microns to about 50 microns, and an air permeability of between about 10 cfm/sf to about 800 cfm/sf. Other ranges are also possible, as described in more detail below.

In general, regardless of the fiber type, the average diameter of the fibers in a pre-filter layer may be, for example, greater than or equal to about 0.1 microns, greater than or equal to about 0.3 microns, greater than or equal to about 0.5 microns, greater than or equal to about 1 micron, greater than or equal to about 5 microns, greater than or equal to about 10 microns, greater than or equal to about 15 microns, greater than or equal to about 20 microns, greater than or equal to about 25 microns, greater than or equal to about 30 microns, or greater than or equal to about 35 microns. In some embodiments, the average diameter of the fibers in the pre-filter layer(s) may be, for example, less than or equal to about 50 microns, less than or equal to about 45 microns, less than or equal to about 40 microns, less than or equal to about 35 microns, less than or equal to about 30 microns, less than or equal to about 25 microns, less than or equal to about 20 microns, less than or equal to about 15 microns, less than or equal to about 10 microns, less than or equal to about 5 microns, less than or equal to about 3 microns, less than or equal to about 1 micron, or less than or equal to about 0.5 microns. Combinations of the above-referenced ranges are also possible (e.g., between 0.1 micron and 50 microns, between 0.1 micron and 40 microns, between 0.3 microns and 35 microns, between 1 micron and 20 microns). In some cases, when fibers (e.g., meltblown fibers, electrospun fibers, other fibers) having a relatively small average fiber diameter (e.g., less than 1 micron, as low as 100-500 nm) are incorporated into a pre-filter, the fibers may be arranged in such a manner (e.g., having a sufficiently low density and/or relatively open pore structure) that results in a structure that has an overall level of permeability suitable for a pre-filter.

In some embodiments, regardless of the fiber content, the basis weight of one or more pre-filter layers, or the entire pre-filter, may be greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². In some instances, the basis weight of one or more pre-filter layers, or the entire pre-filter, may be less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², or less than or equal to about 50 g/m². Combinations of the above-referenced ranges are also possible (e.g., greater than or equal to about 5 g/m² and less than or equal to about 500 g/m², greater than or equal to about 10 g/m² and less than or equal to about 400 g/m²). Other values of basis weight are also possible for various types of pre-filters described herein.

As determined herein, the basis weight for the filter media, or layers thereof, is measured according to the Technical Association of the Pulp and Paper Industry (TAPPI) Standard T410. Basis weight can generally be measured on a laboratory balance that is accurate to 0.1 grams.

In some embodiments, one or more pre-filter layers, or the entire pre-filter, may be designed to have a particular efficiency or range of efficiencies. The efficiency of filtering as measured herein is determined following the ISO 16889 procedure (modified by testing a flat sheet sample) on a Multipass Filter Test Stand manufactured by PTI. The testing uses ISO A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test is run at a face velocity of 0.67 cm/sec until a terminal pressure of 500 kPa above the baseline pressure measured across the test media. Particle counts (particles per milliliter) at the particle size selected (e.g., 1, 3, 4, 5, 7, 10, 15, 20, 25, or 30 microns) upstream and downstream of the media can be taken at ten points equally divided over the time of the test. The average of upstream and downstream particle counts can be taken at each selected particle size. From the average particle count upstream (injected-C₀) and the average particle count downstream (passed thru-C) the filtration efficiency test value for each particle size selected can be determined by the relationship [(1-[C/C₀])*100%].

Efficiency can also be expressed in terms of a Beta value (or Beta ratio), where Beta₍ₓ₎=y is the ratio of upstream count (C₀) to downstream count (C), and where x is the minimum particle size that will achieve the actual ratio of C₀ to C that is equal to y. Here, x can be, for example, 1, 3, 5, 7, 10, 12, 15, 20, 25, 30, 50, 70, or 100, and y can be, for example, at least 2, at least 10, at least 75, at least 100, at least 200, or at least 1000. Other values of x and y are also possible; for instance, in some cases, y may be greater than 1000. For any value of x, y may be any number (e.g., 10.2, 12.4) representing the actual ratio of C₀ to C. Likewise, for any value of y, x may be any number representing the minimum particle size that will achieve the actual ratio of C₀ to C that is equal to y. The penetration fraction of the media is 1 divided by the Beta₍ₓ₎ value (y), and the efficiency fraction is 1—penetration fraction. Accordingly, the efficiency of the media is 100 times the efficiency fraction, and 100*(1-1/Beta₍ₓ₎)=efficiency percentage. For example, a filter media having a Beta₍ₓ₎=200 has an efficiency of [1-(1/200)]*100, or 99.5% for x micron particles.

In some embodiments, one or more pre-filter layers, or the entire pre-filter, may have a micron rating for beta efficiency (e.g., beta 200) of greater than or equal to about 4 microns, greater than or equal to 5 microns, greater than or equal to about 6 microns, greater than or equal to about 8 microns, greater than or equal to about 10 microns, greater than or equal to about 12 microns, greater than or equal to about 15 microns, greater than or equal to about 20 microns, or greater than or equal to about 25 microns. In some instances, the micron rating for beta efficiency (e.g., beta 200) of the one or more pre-filter layers, or the entire pre-filter, may be less than or equal to about 30 microns, less than or equal to about 28 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 14 microns, less than or equal to about 12 microns, less than or equal to about 10 microns, or less than or equal to about 8 microns. For various types of pre-filters, combinations of the above-referenced ranges are possible (e.g., greater than or equal to about 4 microns and less than or equal to about 30 microns).

In some embodiments, the dust holding capacity of one or more pre-filter layers, or a combination of pre-filter layers (e.g., an entire dual-layer pre-filter), may be greater than or equal to about 20 g/m², greater than or equal to about 50 g/m², greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the dust holding capacity may be less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 180 g/m², less than or equal to about 150 g/m², less than or equal to about 125 g/m², less than or equal to about 100 g/m², or less than or equal to about 75 g/m². Combinations of the above-referenced ranges are also possible (e.g., a dust holding capacity of greater than or equal to about 20 g/m² and less than or equal to about 300 g/m², a dust holding capacity of greater than or equal to about 50 g/m² and less than or equal to about 300 g/m²). Other values of dust holding capacity for various types of pre-filters are also possible.

As determined herein, the dust holding capacity is measured according to the multipass filter test described above in accordance with ISO 16889, where the test is conducted up until a terminal pressure of 500 kPa above the baseline pressure measured across the test media. The dust holding capacity is determined from a linear interpolation estimation of the amount of dust collected at 200 kPa, based on the actual amount of dust collected at 500 kPa. That is, once the amount of dust collected at 500 kPa is measured through the ISO 16889 test, the dust holding capacity at 200 kPa is then calculated, according to a linear relationship between the dust holding capacity and the pressure measured across the test media. The dust holding capacity calculated at 200 kPa is the dust holding capacity that is recorded.

In some embodiments, one or more pre-filter layers, or the entire pre-filter, in accordance with the present disclosure may have a mean flow pore size of greater than or equal to about 0.05 microns, greater than or equal to about 0.1 micron, greater than or equal to about 0.5 microns, greater than or equal to about 1 micron, greater than or equal to about 2 microns, greater than or equal to about 3 microns, greater than or equal to about 4 microns, greater than or equal to about 5 microns, greater than or equal to about 6 microns, greater than or equal to about 10 microns, greater than or equal to about 20 microns, greater than or equal to about 30 microns, greater than or equal to about 40 microns, greater than or equal to about 50 microns, greater than or equal to about 65 microns, or greater than or equal to about 80 microns. In some instances, one or more pre-filter layers, or the entire pre-filter, may have a mean flow pore size of less than or equal to about 100 microns, less than or equal to about 90 microns, less than or equal to about 80 microns, less than or equal to about 70 microns, less than or equal to about 60 microns, less than or equal to about 50 microns, less than or equal to about 40 microns, less than or equal to about 25 microns, less than or equal to about 10 microns, less than or equal to about 5 microns, less than or equal to about 1 micron, less than or equal to about 0.5 microns, less than or equal to about 0.1 micron, or less than or equal to about 0.05 microns. Combinations of the above-referenced ranges are also possible (e.g., greater than or equal to about 4 microns and less than or equal to about 100 microns, greater than or equal to about 5 microns and less than or equal to about 90 microns).

As used herein, the mean flow pore size refers to the mean flow pore size measured by using a Capillary Flow Porometer manufactured by Porous Materials, Inc., in accordance with the ASTM F316-03 standard.

The air permeability of one or more pre-filter layers, or the entire pre-filter, as described herein can also be varied as desired. For instance, in some embodiments, one or more pre-filter layers, or a combination of pre-filter layers (e.g., an entire dual-layer pre-filter), may have an air permeability of greater than or equal to about 0.5 cfm/sf, greater than or equal to about 1 cfm/sf, greater than or equal to about 5 cfm/sf, greater than or equal to about 10 cfm/sf, greater than or equal to about 25 cfm/sf, greater than or equal to about 30 cfm/sf, greater than or equal to about 40 cfm/sf, greater than or equal to about 50 cfm/sf, greater than or equal to about 100 cfm/sf, greater than or equal to about 150 cfm/sf, greater than or equal to about 200 cfm/sf, greater than or equal to about 250 cfm/sf, greater than or equal to about 300 cfm/sf, greater than or equal to about 350 cfm/sf, greater than or equal to about 400 cfm/sf, greater than or equal to about 500 cfm/sf, greater than or equal to about 600 cfm/sf, or greater than or equal to about 700 cfm/sf. In some instances, one or more pre-filter layers, or a combination of pre-filter layers (e.g., an entire dual-layer pre-filter), may have an air permeability of less than or equal to about 800 cfm/sf, less than or equal to about 700 cfm/sf, less than or equal to about 600 cfm/sf, less than or equal to about 500 cfm/sf, less than or equal to about 400 cfm/sf, less than or equal to about 375 cfm/sf, less than or equal to about 350 cfm/sf, less than or equal to about 325 cfm/sf, less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, or less than or equal to about 50 cfm/sf. Combinations of the above-referenced ranges are also possible (e.g., greater than or equal to about 10 cfm/sf and less than or equal to about 800 cfm/sf, greater than or equal to about 10 cfm/sf and less than or equal to about 400 cfm/sf, greater than or equal to about 30 cfm/sf and less than or equal to about 350 cfm/sf).

As determined herein, the air permeability of the filter media, or layers thereof (e.g., pre-filter layer, main filtration layer), is measured according to TAPPI Method T251. The permeability of a filter media, or layers thereof, is an inverse function of flow resistance and can be measured with a Frazier Permeability Tester. The Frazier Permeability Tester measures the volume of air per unit of time that passes through a unit area of sample at a fixed differential pressure across the sample. Permeability can be expressed in cubic feet per minute per square foot at a 0.5 inch water differential.

As noted above, the pre-filter may include layers made up of one or more suitable fiber types.

In some embodiments, the pre-filter layer(s) include glass fibers. The glass fibers of the pre-filter layer(s) may include microglass fibers, chopped strand glass fibers, or a combination thereof. Microglass fibers and chopped strand glass fibers are known to those skilled in the art. One skilled in the art is able to determine whether a glass fiber is microglass or chopped strand by observation (e.g., optical microscopy, electron microscopy). Microglass fibers may also have chemical differences from chopped strand glass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics.

In general, chopped strand glass fibers are drawn from bushing tips and cut into fibers in a process similar to textile production. Chopped strand glass fibers are produced in a more controlled manner than microglass fibers, and as a result, chopped strand glass fibers will generally have less variation in fiber diameter and length than microglass fibers. Microglass fibers are drawn from bushing tips and further subjected to flame blowing or rotary spinning processes. In some cases, fine microglass fibers may be made using a remelting process. In this respect, microglass fibers may be fine or coarse. As used herein, fine microglass fibers are less than 1 micron in diameter and coarse microglass fibers are greater than or equal to 1 micron in diameter.

In embodiments in which one or more layers of the pre-filter, and/or the pre-filter as a whole, comprises microglass fibers, the microglass fibers can have small diameters such that the average diameter of the fibers is less than 10.0 microns. For example, the average diameter of the microglass fibers in the pre-filter layer may be between 0.1 microns to about 9.0 microns; and, in some embodiments, between about 0.3 microns and about 6.5 microns, or between about 1.0 microns and 5.0 microns. In certain embodiments, the microglass fibers may have an average fiber diameter of less than about 7.0 microns, less than about 5.0 microns, less than about 3.0 microns, or less than about 1.0 microns. Average diameter distributions for microglass fibers are generally log-normal. However, it can be appreciated that microglass fibers may be provided in any other appropriate average diameter distribution (e.g., Gaussian distribution).

The microglass fibers may vary significantly in length as a result of process variations. The aspect ratios (length to diameter ratio) of the microglass fibers in a pre-filter layer may be generally in the range of about 100 to 10,000. In some embodiments, the aspect ratio of the microglass fibers in a pre-filter layer are in the range of about 200 to 2500; or, in the range of about 300 to 600. In some embodiments, the average aspect ratio of the microglass fibers in a pre-filter layer may be about 1,000; or about 300. It should be appreciated that the above-noted dimensions are not limiting and that the microglass fibers may also have other dimensions.

Coarse microglass fibers, fine microglass fibers, or a combination of microglass fibers thereof may be included within one or more layers of the pre-filter. In some embodiments, coarse microglass fibers may make up between about 20% by weight and about 90% by weight of the glass fibers of one or more layers of the pre-filter, and/or of the pre-filter as a whole. In some cases, for example, coarse microglass fibers make up between about 30% by weight and about 60% by weight of the glass fibers, or between about 40% by weight and about 60% by weight of the glass fibers of one or more layers of the pre-filter, or of the pre-filter as a whole. For certain embodiments that include fine microglass fibers, the fine microglass fibers make up between about 0% and about 70% by weight of the glass fibers of one or more layers of the pre-filter, and/or of the pre-filter as a whole. In some cases, for example, fine microglass fibers make up between about 5% by weight and about 60% by weight of the glass fibers, or between about 30% by weight and about 50% by weight of the glass fibers of one or more layers of the pre-filter, and/or of the pre-filter as a whole.

Chopped strand glass fibers may have an average fiber diameter that is greater than the diameter of the microglass fibers of one or more layers of the pre-filter, or of the pre-filter as a whole. In some embodiments, chopped strand glass fiber has a diameter of greater than about 5 microns. For example, the diameter range may be up to about 30 microns. In some embodiments, chopped strand glass fibers may have a fiber diameter between about 5 microns and about 12 microns. In certain embodiments, chopped strand fibers may have an average fiber diameter of less than about 10.0 microns, less than about 8.0 microns, less than about 6.0 microns. Average diameter distributions for chopped strand glass fibers are generally log-normal. Chopped strand diameters tend to follow a normal distribution. Though, it can be appreciated that chopped strand glass fibers may be provided in any appropriate average diameter distribution (e.g., Gaussian distribution). In some embodiments, chopped strand glass fibers may have a length in the range of between about 0.125 inches and about 1 inch (e.g., about 0.25 inches, or about 0.5 inches).

It should be appreciated that the above-noted dimensions are not limiting and that the microglass, chopped strand fibers and/or other glass fibers may also have other dimensions. Any suitable amount of chopped strand fibers can be used in one or more layers of the pre-filter, or in the pre-filter as a whole. In some cases, one or more layers of the of the pre-filter includes a relatively low percentage of chopped strand fibers. For example, one or more layers of the pre-filter may include less than 30 wt %, or less than 20 wt %, or less than 10 wt %, or less than 5 wt %, or less than 2 wt %, or less than 1 wt % of chopped strand fiber. In some cases, one or more layers of the pre-filter does not include any chopped strand fibers. It should be understood that, in certain embodiments, one or more layers of the pre-filter do not include chopped strand fibers within the above-noted ranges.

In certain embodiments, the ratio between the weight percentage of microglass fibers and chopped strand glass fibers provides for different characteristics in various layers of the pre-filter. Accordingly, in some embodiments, one or more layers of the pre-filter or of the pre-filter as a whole includes a relatively large percentage of microglass fibers compared to chopped strand glass fibers. For example, at least 70 wt %, or at least 80 wt %, at least 90 wt %, at least 93 wt %, at least 95 wt %, at least 97 wt %, or at least 99 wt % of the fibers of a pre-filter layer may be microglass fibers. In certain embodiments, all of the fibers of a pre-filter layer are microglass fibers. In other embodiments, however, one or more layers of the pre-filter or of the pre-filter as a whole includes a relatively high percentage of chopped strand fibers compared to microglass fibers. For example, at least 50 wt %, at least 60 wt %, at least 70 wt %, or at least 80 wt %, at least 90 wt %, at least 93 wt %, at least 95 wt %, at least 97 wt %, or at least 99 wt % of the fibers of a pre-filter layer may be chopped strand fibers. Such percentages of chopped strand fibers may be particularly useful in certain embodiments for micron ratings greater than 15 microns for Beta₍ₓ₎=200. In certain embodiments, all of the fibers of a pre-filter layer are chopped strand fibers.

In some embodiments, one or more layers of the pre-filter or of the pre-filter as a whole includes a relatively large percentage of microglass fiber with respect to all of the components used to form the layer. For example, one or more pre-filter layers may include at least about 40 wt %, at least about 50 wt %, at least about 60 wt %, at least about 70 wt %, or at least about 80 wt %, at least about 90 wt %, at least about 93 wt %, at least about 95 wt %, at least about 97 wt %, or at least about 99 wt % of microglass fiber. In one particular embodiment, one or more pre-filter layers includes between about 90 wt % and about 99 wt %, e.g., between about 90 wt % and about 95 wt % microglass fibers. In another embodiment, one or more pre-filter layers includes between about 40 wt % to about 80 wt % microglass fibers, or between about 60 wt % to about 80 wt % microglass fibers. It should be understood that, in certain embodiments, one or more layers of the pre-filter do not include microglass fiber within the above-noted ranges or at all.

One or more layers of the pre-filter or of the pre-filter as a whole may include microglass fibers having an average fiber diameter within a certain range and making up a certain range of weight percentage of the layer(s). For instance, one or more layers of the pre-filter may include microglass fibers having an average fiber diameter of less than 5 microns making up greater than about 50%, greater than about 60%, greater than about 70%, greater than about 80%, greater than about 90%, greater than about 93%, or greater than about 97% of the microglass fibers of the layer(s); or alternatively, less than about 50%, less than about 40%, less than about 30%, less than about 20%, less than about 10%, or less than about 5% of the microglass fibers of the layer(s). In some cases, a pre-filter layer includes 0% of microglass fibers having an average diameter of less than 5 microns.

Additionally or alternatively, the one or more layers of the pre-filter or of the pre-filter as a whole may include microglass fibers having an average fiber diameter of greater than or equal to 5 microns making up greater than about 50%, greater than about 60%, greater than about 70%, greater than about 80%, greater than about 90%, greater than about 93%, or greater than about 97% of the microglass fibers of the layer(s); or, less than about 50%, less than about 40%, less than about 30%, less than about 20%, less than about 10%, or less than about 5% of the microglass fibers of the layer(s). In some cases, one or more layers of the pre-filter includes 0% of microglass fibers having an average diameter of greater than or equal to 5 microns. It should be understood that, in certain instances, one or more layers of the pre-filter include microglass fibers within ranges different than those described above.

In certain embodiments, regardless of whether the glass fibers in a pre-filter layer are microglass or chopped fibers, one or more layers of the pre-filter may include a large percentage of glass fiber (e.g., microglass fibers and/or chopped strand glass fibers). For example, one or more pre-filter layers may comprise at least about 40 wt %, at least about 50 wt %, at least about 60 wt %, at least about 70 wt %, at least about 80 wt %, at least about 90 wt %, or at least about 95 wt % glass fibers. In some cases, all of the fibers of a layer (e.g., the first and/or second layers of a pre-filter) are formed of glass. It should be understood that, in certain embodiments, one or more pre-filter layers do not include glass fibers within the above-noted ranges or at all.

In certain embodiments, one or more layers of the pre-filter includes a mixture of fibrillated fibers, glass fibers, and/or synthetic fibers, amongst other optional components (e.g., binder resin).

For some embodiments, pre-filter layers may include an appreciable amount of glass fibers, for example, along with fibrillated fibers. For example, one or more pre-filter layers may include fibrillated fibers mixed together with glass fibers, such as glass fibers described herein.

Though, in some instances, pre-filter layers may include limited amounts of, or no, glass fibers therein. The respective characteristics and amounts of fibrillated and non-fibrillated fibers may be selected to impart desirable properties including mechanical properties (e.g., elongation and strength) and filtration properties (e.g., dust holding capacity and efficiency), amongst other benefits.

As noted above, some embodiments of fiber webs used in a pre-filter include fibrillated fibers (e.g., lyocell fibers). As known to those of ordinary skill in the art, a fibrillated fiber includes a parent fiber that branches into smaller diameter fibrils which can, in some instances, branch further out into even smaller diameter fibrils with further branching also being possible. The branched nature of the fibrils leads to a fiber web having a high surface area and can increase the number of contact points between the fibrillated fibers and other fibers in the web. Such an increase in points of contact between the fibrillated fibers and other fibers and/or components of the web may contribute to enhancing mechanical properties (e.g., flexibility, strength) and/or filtration performance properties of the fiber web.

A fibrillated fiber may be formed of any suitable materials such as synthetic materials (e.g., synthetic polymers such as polyester, polyamide, polyaramid, aramid, paramid, polyimide, polyethylene, polypropylene, polyether ether ketone, polyethylene terephthalate, polyolefin, nylon, acrylics, liquid crystalline polymers, regenerated cellulose (e.g., lyocell, rayon), polyoxazole (e.g., poly(p-phenylene-2,6-bezobisoxazole) (PBO)), and natural materials (e.g., natural polymers such as non-regenerated cellulose, wood, cellulose non-wood, cotton). In some embodiments, organic polymer fibers are used.

In some embodiments, fibrillated fibers may be synthetic fibers. Synthetic fibers as used herein, are non-naturally occurring fibers formed of polymeric material. Fibrillated fibers may also be non-synthetic fibers, for example, cellulose fibers that are naturally occurring. It can be appreciated that fibrillated fibers may include any suitable combination of synthetic and/or non-synthetic fibers. In general, the fibrillated fibers may include any suitable level of fibrillation. The level of fibrillation relates to the extent of branching in the fiber. The level of fibrillation may be measured according to any number of suitable methods.

For example, the level of fibrillation of the fibrillated fibers can be measured according to a Canadian Standard Freeness (CSF) test, specified by TAPPI test method T 227 om 09 Freeness of pulp. The test can provide an average CSF value.

In certain embodiments, the average CSF value of the fibrillated fibers used in one or more layers of the pre-filter may be greater than or equal to 1 mL, greater than or equal to about 10 mL, greater than or equal to about 20 mL, greater than or equal to about 35 mL, greater than or equal to about 45 mL, greater than or equal to about 50 mL, greater than or equal to about 65 mL, greater than or equal to about 70 mL, greater than or equal to about 75 mL, greater than or equal to about 80 mL, greater than or equal to about 100 mL, greater than or equal to about 110 mL, greater than or equal to about 120 mL, greater than or equal to about 130 mL, greater than or equal to about 140 mL, greater than or equal to about 150 mL, greater than or equal to about 175 mL, greater than or equal to about 200 mL, greater than or equal to about 250 mL, greater than or equal to about 300 mL, greater than or equal to about 350 mL, greater than or equal to about 400 mL, greater than or equal to about 500 mL, greater than or equal to about 600 mL, greater than or equal to about 650 mL, greater than or equal to about 700 mL, or greater than or equal to about 750 mL.

In some embodiments, the average CSF value of the fibrillated fibers used in one or more layers of the pre-filter may be less than or equal to about 800 mL, less than or equal to about 750 mL, less than or equal to about 700 mL, less than or equal to about 650 mL, less than or equal to about 600 mL, less than or equal to about 550 mL, less than or equal to about 500 mL, less than or equal to about 450 mL, less than or equal to about 400 mL, less than or equal to about 350 mL, less than or equal to about 300 mL, less than or equal to about 250 mL, less than or equal to about 225 mL, less than or equal to about 200 mL, less than or equal to about 150 mL, less than or equal to about 140 mL, less than or equal to about 130 mL, less than or equal to about 120 mL, less than or equal to about 110 mL, less than or equal to about 100 mL, less than or equal to about 90 mL, less than or equal to about 85 mL, less than or equal to about 70 mL, less than or equal to about 50 mL, less than or equal to about 40 mL, or less than or equal to about 25 mL. Combinations of the above-referenced lower limits and upper limits are also possible. It should be understood that, in certain embodiments, the fibers may have fibrillation levels outside the above-noted ranges. The average CSF value of the fibrillated fibers used in the pre-filter layer(s) may be based on one type of fibrillated fiber or more than one type fibrillated fiber.

In certain preferred embodiments, the fibrillated fibers are formed of lyocell. Lyocell fibers are known to those of skill in the art as a type of synthetic fiber and may be produced from regenerated cellulose by solvent spinning.

In certain embodiments, the fibrillated fibers are formed of rayon. Rayon fibers are also produced from regenerated cellulose and may be produced using an acetate method, a cuprammonium method, or a viscose process. In these methods, the cellulose or cellulose solution may be spun to form fibers.

Fibers may be fibrillated through any appropriate fibrillation refinement process. In some embodiments, fibers (e.g., lyocell fibers) are fibrillated using a disc refiner, a stock beater or any other suitable fibrillating equipment.

In general, the fibrillated fibers may have any suitable dimensions (e.g., dimensions measured via a microscope).

As noted above, fibrillated fibers include parent fibers and fibrils. The parent fibers may have an average diameter of less than about 75 microns; in some embodiments, less than about 60 microns; in some embodiments, less than about 50 microns; in some embodiments, less than about 40 microns; in some embodiments, less than about 30 microns; in some embodiments, less than about 20 microns; in some embodiments, less than about 15 microns; and in some embodiments, less than about 10 microns. The fibrils may have an average diameter of less than about 15 microns; in some embodiments, less than about 10 microns; in some embodiments, less than about 6 microns; in some embodiments, less than about 4 microns; in some embodiments, less than about 3 microns; in some embodiments, less than about 1 micron; and in some embodiments, less than about 0.5 microns. For example, the fibrils may have a diameter of between about 0.1 micron and about 15 microns, between about 0.1 micron and about 10 microns, between about 1 micron and about 10 microns, between about 3 microns and about 10 microns, between about 3 microns and about 6 microns, between about 0.1 micron and about 6 microns, between about 0.1 micron and about 2 microns, between about 0.1 micron and about 1.5 microns, or between about 0.3 microns and about 0.7 microns.

The fibrillated fibers described may have an average length of greater than about 1 mm, greater than about 2 mm, greater than about 3 mm, greater than about 4 mm, greater than about 5 mm, greater than about 6 mm, greater than about 10 mm, or greater than about 15 mm. The fibrillated fibers may have an average length of less than about 15 mm, less than about 10 mm, less than about 6 mm, less than about 5 mm, less than about 4 mm, less than about 3 mm, less than about 2 mm, or less than about 1 mm. It should be understood that the average length of the fibrillated fibers may be between any of the above-noted lower limits and upper limits. For example, the average length of the fibrillated fibers may be between about 0.1 and about 15 mm, between about 0.2 and about 12 mm, between about 0.5 and about 10 mm, between about 1 and about 10 mm, between about 1 and about 5 mm, between about 2 mm and about 4 mm, between about 0.1 and about 2 mm, between about 0.1 and about 1.2 mm, or between about 0.8 mm and about 1.1 mm. The average length of the fibrillated fibers refers to the average length of parent fibers from one end to an opposite end of the parent fibers. In some embodiments, the maximum average length of the fibrillated fibers fall within the above-noted ranges. The maximum average length refers to the average of the maximum dimension along one axis of the fibrillated fibers (including parent fibers and fibrils).

The above-noted dimensions may be, for example, when the fibrillated fibers are lyocell or the fibrillated fibers are a material other than lyocell. It should be understood that, in certain embodiments, the fibers and fibrils may have dimensions outside the above-noted ranges.

Various embodiments of fiber webs provided in the whole pre-filter or one or more layers of the pre-filter may include any suitable weight percentage of fibrillated fibers to achieve the desired balance of properties. In some embodiments, the weight percentage of the fibrillated fibers in the fiber web is about 1.0 weight % or greater, about 2.5 weight % or greater, about 5.0 weight % or greater, about 10 weight % or greater, about 15 weight % or greater, or about 20 weight % or greater. In some embodiments, the weight percentage of the fibrillated fibers in the web is about 60 weight % or less, about 50 weight % or less, about 30 weight % or less, or about 21 weight % or less. It should be understood that the weight percentage of fibrillated fibers in the fiber web may be between any of the above-noted lower limits and upper limits. For example, the weight percentage may be between about 1 weight % and about 60 weight %; in some embodiments, between about 2.5 weight % and about 60 weight %, between about 5.0 weight % and about 30 weight %, between about 15 weight % and about 25 weight %; in some embodiments, between about 5 weight % and about 60 weight %; in some embodiments, between about 10 weight % and about 50 weight %; in some embodiments, between about 10 weight % and about 40 weight %; in some embodiments, between about 10 weight % and about 30 weight %; in some embodiments, between about 10 weight % and about 25 weight %; in some embodiments, between about 12 weight % and about 21 weight %; in some embodiments, between about 10 weight % and about 20 weight %, between about 1 weight % and about 10 weight %, between about 2.5 weight % and about 10 weight %, between about 5 weight % and about 10 weight %, between about 1 weight % and about 15 weight %, between about 2.5 weight % and about 15 weight %, between about 5 weight % and about 15 weight %, between about 10 weight % and about 15 weight %, between about 1 weight % and about 20 weight %, between about 2.5 weight % and about 20 weight %, between about 5 weight % and about 20 weight %, between about 15 weight % and about 20 weight %, and the like.

As noted above, in addition to fibrillated fibers, one or more layers of the pre-filter, or the pre-filter as a whole, may include glass fibers. For example, glass fibers may comprise greater than about 50% by weight of the pre-filter layer(s); in some embodiments, greater than about 60% by weight; in some embodiments, greater than about 70% by weight; and, in some embodiments, greater than about 80% by weight.

For pre-filters that include both glass fibers and fibrillated fibers, any suitable amount of microglass fibers and chopped strand glass fibers may be used with the fibrillated fibers. In certain embodiments, the ratio between the weight percentage of microglass fibers and chopped strand glass fibers provides for different characteristics. In some embodiments, the pre-filter layer(s) may include a relatively large percentage of microglass fibers compared to chopped strand glass fibers. For example, microglass may be provided in an amount greater than 40% by weight of the pre-filter layer(s); in some embodiments, greater than 50% by weight of the pre-filter layer(s); in some embodiments, greater than 60% by weight of the pre-filter layer(s); and, in some embodiments, greater than 70% by weight of the pre-filter layer(s), greater than 90 wt % of the pre-filter layer(s), or greater than 95 wt % of the pre-filter layer(s). In certain embodiments, the pre-filter layer(s) includes ranges of microglass fibers outside of the above-noted ranges.

In general, any suitable amount of chopped strand fibers can be used with fibrillated fibers. In some embodiments, the pre-filter layer(s) may include a relatively low percentage of chopped strand fibers. For example, in some embodiments, the pre-filter layer(s) may include between about 1% by weight and about 30% by weight chopped strand fibers; in some embodiments, between about 5% by weight and about 30% by weight; and, in some embodiments, between about 10% by weight and about 20% by weight. In some cases, the pre-filter layer(s) might not include any chopped strand fibers. It should be understood that, in certain embodiments, the pre-filter layer(s) do not include chopped strand fibers within the above-noted ranges.

In some embodiments, fiber webs provided in one or more layers of the pre-filter having an amount of fibrillated fibers that is greater than that of other fiber webs may exhibit a comparatively greater degree of flexibility and strength, for example, an increased elongation, tensile strength and/or burst strength than the other fiber webs.

In some cases, it may be advantageous for the fibrillated fibers to be aligned in the machine direction of the web (i.e., when a fiber's length extends substantially in the machine direction) and/or in the cross-machine direction of the web (i.e., when a fiber's length extends substantially in the cross-machine direction). It should be understood that the terms “machine direction” and “cross-machine” direction have their usual meanings in the art. That is, the machine direction refers to the direction in which the fiber web moves along the processing machine during processing and the cross-machine direction refers to a direction perpendicular to the machine direction.

The amount of fibrillated fibers and the level of fibrillation may vary between fiber web layers of the pre-filter. For example, the relative amount of fibrillated fibers and the level of fibrillation may vary when a first layer of a pre-filter is an upstream layer and a second layer of the pre-filter is a downstream layer. In some embodiments, an upstream layer has a lesser degree of fibrillation (i.e., greater average CSF) than a downstream layer. Alternatively, in other embodiments, an upstream layer has a greater degree of fibrillation than a downstream layer. In some embodiments, the percentage of fibrillated fibers in an upstream layer is comparatively smaller than the percentage of fibrillated fibers in a downstream layer. Or, in other embodiments, the percentage of fibrillated fibers in an upstream layer is greater than the percentage of fibrillated fibers in a downstream layer.

In certain embodiments in which a pre-filter of a filter media includes at least first and second layers, where the second layer is located downstream of the first layer, the second layer may include more fibrillated fibers than the first layer (e.g., at least 5%, at least 10%, at least 20%, at least 40%, at least 60%, at least 80%, at least 100%, at least 150%, at least 200%, at least 300%, at least 400%, at least 500%, or at least 1000% more fibrillated fibers than the first layer). For example, the second layer may include more fibrillated fibers than the first layer by a percent difference of between about 5% and about 500%, between about 5% and about 10%, between about 5% and about 20%, between about 10% and about 20%, between about 5% and about 30%, between about 5% and about 40%, between about 20% and about 30%, between about 30% and about 40%, between about 10% and about 50%, between about 5% and about 50%, between about 20% and about 50%, between about 30% and about 50%, between about 10% and about 100%, between about 50% and about 200%, between about 100% and about 300%, or between about 300% and about 500%. Other ranges are also possible. In some embodiments, fiber webs having relatively greater amounts of fibrillated fibers than other fiber webs may, in general, exhibit a comparatively lesser degree of permeability.

In some cases, the same amount of fibrillated fibers are present in each of the layers. In some embodiments in which a pre-filter includes at least first and second layers, the second layer may include fibrillated fibers having a higher degree of fibrillation than the fibrillated fibers of the first layer. For example, the average CSF value of the fibrillated fibers of the first layer may be at least 5%, at least 10%, at least 20%, at least 40%, at least 60%, at least 80%, at least 100%, at least 150%, at least 200%, at least 300%, at least 400%, or at least 500% greater than the average CSF value of the fibrillated fibers of the second layer. For example, the average CSF value of the fibrillated fibers of the first layer may be greater than the average CSF value of the fibrillated fibers of the second layer by between about 5% and about 500%, between about 5% and about 10%, between about 5% and about 20%, between about 10% and about 20%, between about 5% and about 30%, between about 5% and about 40%, between about 20% and about 30%, between about 30% and about 40%, between about 10% and about 50%, between about 5% and about 50%, between about 20% and about 50%, between about 30% and about 50%, between about 10% and about 100%, between about 50% and about 200%, between about 100% and about 300%, or between about 300% and about 500%. Other ranges are also possible. In some embodiments, fiber webs including fibers with a relatively greater degree of fibrillation than other fiber webs may, in general, exhibit a comparatively lesser degree of permeability. In some cases, the fibrillated fibers in each of the layers has the same level of fibrillation.

As noted above, one or more layers of the pre-filter of the filter media may include non-fibrillated synthetic fibers, formed of polymeric materials. Non-fibrillated synthetic fibers may include any suitable type of synthetic polymer including thermoplastic polymers. Examples of suitable synthetic fibers that are non-fibrillated may include polyester, polyamide, polyaramid, polyimide, polyethylene, polypropylene, polyether ether ketone, polyethylene terephthalate, polyolefin, nylon, and combinations thereof. It should be understood that other types of synthetic polymer fiber types may also be used.

One or more layers of the pre-filter, or the pre-filter as a whole, may include a suitable percentage of synthetic fibers other than fibrillated fibers. In some embodiments, the weight percentage of such synthetic fibers in a pre-filter, or layer(s) of the pre-filter, may be about 10 weight % or greater, about 20 weight % or greater, about 30 weight % or greater, about 40 weight % or greater, about 50 weight % or greater, about 60 weight % or greater, about 70 weight % or greater, or about 80 weight % or greater. In some embodiments, the weight percentage of synthetic fibers in the fiber web is about 95 weight % or less, about 90 weight % or less, about 80 weight % or less, about 70 weight % or less, about 60 weight % or less, or about 50 weight % or less. It should be understood that the weight percentage of synthetic fibers in the pre-filter, or layer(s) of the pre-filter, may be between any of the above-noted lower limits and upper limits. For example, the weight percentage may be between about 10 weight % and about 95 weight %, between about 20 weight % and about 95 weight %, between about 30 weight % and about 95 weight %, between about 30 weight % and about 90 weight %, between about 40 weight % and about 80 weight %, and the like. It can be appreciated that it may also be possible for synthetic fibers other than fibrillated fibers to be incorporated within the pre-filter, or layer(s) of the pre-filter, outside of the ranges disclosed.

In some embodiments, the fiber web layer(s) of the pre-filter may include multiple types of synthetic fibers. For example, synthetic fibers may include staple fibers that are cut to a suitable average length and are appropriate for incorporation into a wet-laid or dry-laid process for forming a filter media. In some cases, groups of staple fibers may be cut to have a particular length with only slight variations in length between individual fibers. In some embodiments, the synthetic fibers may be binder fibers, such as mono-component fibers (i.e., having a single composition) or multi-component fibers (i.e., having multiple compositions such as bi-component fiber). In some embodiments, a fiber web of a pre-filter may include a suitable percentage of mono-component fibers and/or multi-component fibers (e.g., bi-component fibers), as known to those of skill in the art. In some embodiments, all of the synthetic fibers are mono-component fibers. In some embodiments, at least a portion of the synthetic fibers are multi-component fibers.

In some embodiments, one or more layers of the pre-filter may be produced from a meltblown process. As discussed above, while the average fiber diameter of meltblown fibers are generally low, as discussed above, when fabricated as a pre-filter layer, the meltblown fibers may be arranged according to a certain density so as to give rise to a fiber web that exhibits a relatively open pore structure, having a permeability that is higher in comparison to the permeability of the main filtration layer.

As discussed above, the pre-filter of the filter media may have a single layer (e.g., fiber web), or multiple layers (e.g., multiple fiber webs). In some embodiments of a pre-filter of the filter media involving multiple layers, a clear demarcation of layers may or may not be apparent.

In some embodiments, the pre-filter of the filter media includes a clear demarcation between layers. For example, the pre-filter may include an interface between two layers that is distinct. In some such embodiments, the layers may be formed separately, and combined by any suitable method such as lamination, collation, or by use of adhesives.

In other embodiments, the pre-filter of the filter media does not include a clear demarcation between layers. For example, a distinct interface between two layers may not be apparent. In some cases, the layers forming a pre-filter may be indistinguishable from one another across the thickness of the pre-filter. The layers may be formed by the same process (e.g., a wet laid process, a non-wet laid process, a spinning process, a meltblown process, or any other suitable process) or by different processes. In some instances, adjacent layers may be formed simultaneously.

Fiber webs for pre-filters described herein may be produced using suitable processes, such as using a wet laid or a a non-wet laid process, as known in the art. In general, a wet laid process involves mixing together of the fibers, to provide a fiber slurry. In some cases, the slurry is an aqueous-based slurry. In certain embodiments, different fibers are optionally stored separately, or in combination, in various holding tanks prior to being mixed together (e.g., to achieve a greater degree of uniformity in the mixture).

Any suitable method for creating a fiber slurry may be used. In some cases, additional additives are added to the slurry to facilitate processing. The temperature may also be adjusted to a suitable range, e.g., between 33° F. and 100° F., or between 50° F. and 85° F. In some embodiments, the temperature of the slurry is maintained, or the temperature might not be actively adjusted.

In some embodiments, the wet laid process uses similar equipment as a conventional papermaking process, which includes a hydropulper, a former or a headbox, a dryer, and an optional converter. For example, the slurry may be prepared in one or more pulpers. After appropriately mixing the slurry in a pulper, the slurry may be pumped into a headbox, where the slurry may or may not be combined with other slurries or additives. The slurry may also be diluted with additional water such that the final concentration of fiber is in a suitable range, such as for example, between about 0.1% to 0.5% by weight.

In certain embodiments involving the formation of a glass fiber slurry, the pH of the glass fiber slurry may be adjusted as desired. For instance, the pH of the glass fiber slurry may range between about 1.5 and about 4.5, or between about 2.6 and about 3.2.

Before the slurry is sent to a headbox, the slurry may be passed through centrifugal cleaners for removing unfiberized glass or shot. The slurry may or may not be passed through additional equipment such as refiners or deflakers to further enhance the dispersion of the fibers. Fibers may then be collected on a screen or wire at an appropriate rate using any suitable machine, e.g., a fourdrinier, a rotoformer, a cylinder, or an inclined wire fourdrinier.

In some embodiments, the process involves introducing binder resin (and/or other components) into a pre-filter layer. In some embodiments, as the pre-filter layer is passed along an appropriate screen or wire, different components included in the binder resin, which may be in the form of separate emulsions, are added to the layer using a suitable technique. In some cases, each component of the binder resin is mixed as an emulsion prior to being combined with the other components and/or the layer. In some embodiments, the components included in the binder may be pulled through the layer using, for example, gravity and/or vacuum. In some embodiments, one or more of the components included in the binder resin may be diluted with softened water and pumped into the layer.

In certain embodiments, two or more layers of a pre-filter are formed by a wet laid process. For example, a first dispersion or slurry (e.g., a pulp) containing fibers in a solvent (e.g., an aqueous solvent such as water) can be applied onto a wire conveyor in a papermaking machine (e.g., a fourdrinier or a rotoformer) to form first layer supported by the wire conveyor. A second dispersion or slurry (e.g., another pulp) containing fibers in a solvent (e.g., an aqueous solvent such as water) is applied onto the first layer either at the same time or subsequent to deposition of the first layer on the wire. Vacuum is continuously applied to the first and second dispersions of fibers during the above process to remove the solvent from the fibers, thereby resulting in a composite article containing first and second layers. The article thus formed is then dried and, if necessary, further processed (e.g., calendered) by using known methods to form multi-layered fiber webs. In some embodiments, such a process may result in a gradient in at least one property across the thickness of the two or more layers.

This fabrication process may result in at least a portion of the fibers in the first layer being intertwined with at least a portion of the fibers from the second layer (e.g., at the interface between the two layers). Additional layers can also be formed and added using a similar process or a different process such as lamination, co-pleating, or collation (i.e., placed directly adjacent one another and kept together by pressure). For example, in some cases, two layers (e.g., two pre-filter layers) are formed into a composite article by a wet laid process in which separate fiber slurries are laid one on top of the other as water is drawn out of the slurry, and the composite article is then combined with a third layer (e.g., a main filtration layer) by any suitable process (e.g., lamination, co-pleating, or collation). It can be appreciated that filter media or composite article formed by a wet laid process may be suitably tailored not only based on the components of each fiber layer, but also according to the effect of using multiple fiber layers of varying properties in appropriate combination to form filter media having the characteristics described herein.

In some embodiments, the pre-filter is coated. For example, the coating may be applied as the fiber layer is passed along an appropriate screen or wire. Different components included in a binder resin, which may be in the form of separate emulsions, may be added to the fiber layer using a suitable technique. In some cases, each component of the binder resin is mixed as an emulsion prior to being combined with the other components and/or fiber layer. In some embodiments, the components included in the binder resin may be pulled through the fiber layer using, for example, gravity and/or vacuum. In some embodiments, one or more of the components included in the binder resin may be diluted with softened water and pumped into the fiber layer. In other embodiments, a binder resin may be introduced to the fiber layer by spraying onto the formed web, or by any other suitable method, such as for example, size press application, foam saturation, curtain coating, rod coating, amongst others. In some embodiments, a binder resin may be applied to a fiber slurry prior to introducing the slurry into a headbox. For example, the binder resin may be introduced (e.g., injected) into the fiber slurry and impregnated with and/or precipitated on to the fibers.

As discussed further below, a coating (e.g., binder resin) may be used in the formation of a main filtration layer, independent from, or together with, the use of a binder resin to form the pre-filter layer(s). The coating may include any suitable material, such as those described herein with respect to the main filtration layer, or other appropriate materials.

The coating (e.g., binder resin) of the pre-filter may impregnate, saturate or otherwise coat the fibers of the pre-filter. The coating may make up a suitable weight percentage of the pre-filter layer(s) of the filter media. In some embodiments, the weight percentage of coating within one or more layers of the pre-filter layer(s) is greater than 0%, greater than about 5%, greater than about 10%, greater than about 15%, greater than about 20%, greater than about 25%, greater than about 30%, greater than about 35%, greater than about 40%, greater than about 45%, greater than about 50%, greater than about 55%, or greater than about 60%. In some embodiments, the weight percentage of coating within one or more layers of the pre-filter layer(s) is less than about 60%, less than about 55%, less than about 50%, less than about 45%, less than about 40%, less than about 35%, less than about 30%, less than about 25%, less than about 20%, less than about 15%, less than about 10%, or less than about 5%. Combinations of the above-referenced ranges are also possible.

Various types of coating(s) that may be incorporated within the pre-filter and/or other portions of the overall filter media are further described below. For example, in some embodiments, methods and materials used for coating the pre-filter as described may be used to coat the main filtration layer.

In other embodiments, a non-wet laid process is used. For example, an air laid process or a carding process may be used. In one example of an air laid process, fibers may be mixed while air is blown onto a conveyor, and a binder is then applied. In a carding process, in some embodiments, the fibers are manipulated by rollers and extensions (e.g., hooks, needles) associated with the rollers prior to application of the binder. In some cases, forming the fiber webs through a dry laid process may be more suitable for the production of a highly porous media. The dry fiber web may be impregnated (e.g., via saturation, spraying, etc.) with any suitable binder resin, as discussed above.

It should be understood that one or more layers of the pre-filter may, or may not, include other components in addition to those described above. Typically, any additional components, are present in limited amounts, e.g., less than 5% by weight. For example, in some embodiments, the pre-filter may include surfactants, coupling agents, crosslinking agents, and/or conductive additives, amongst others.

As discussed above, the overall filter media may include additional layers along with the pre-filter layer(s). For example, while a pre-filter of the filter media may include one or more layers (e.g., dual layer pre-filter), at least one additional layer may be provided (e.g., placed adjacent and/or in contact with the pre-filter) as a main filtration layer. In some embodiments, the main filtration layer may include a suitable composition of fibers, for example, continuous polymeric synthetic fibers (e.g., meltblown fibers, meltspun fibers, melt electrospun fibers, solvent electrospun fibers, and/or centrifugal spun fibers), synthetic staple fibers, or another type of fiber. In some embodiments, the fibers of the main filtration layer may generally be finer and arranged to exhibit a relatively closed pore structure in comparison to the fibers of the pre-filter, leading to a comparatively higher efficiency and lower permeability. In some instances, similar to various embodiments of the pre-filter, the main filtration layer may be made up of several fiber web layers.

In accordance with aspects of the present disclosure, the main filtration layer may be suitably coated, for example, saturated or impregnated, with a resin material. Coating the main filtration layer may be effective to enhance overall filtration properties and performance of the filter media. For various embodiments, the main filtration layer may itself be coated and then laminated with a pre-filter to form a filter media; or, the main filtration layer, together with the pre-filter, laminated or collated therewith, may be coated together concurrently with a suitable resin.

As discussed herein, the main filtration layer of the filter media may be formed of continuous synthetic fibers (e.g., synthetic polymer fibers formed from a meltblown process, a meltspinning process, a melt electrospinning process, a solvent electrospinning process, and/or a centrifugal spinning process). In some embodiments, the continuous synthetic fibers of the main filtration layer may have an average diameter of less than about 15.0 microns, less than about 10.0 microns, less than about 5.0 microns, less than about 3.0 microns, less than about 2.0 microns, less than about 1.5 microns (e.g., less than about 1.4 microns, less than about 1.3 microns, less than about 1.2 microns, less than about 1.1 microns, less than about one micron), less than about 1.0 micron, less than about 0.9 microns, less than about 0.8 microns, less than about 0.7 microns, less than about 0.6 microns, less than about 0.5 microns, less than about 0.4 microns, less than about 0.3 microns, less than about 0.2 microns, less than about 0.1 micron, less than about 0.05 microns, or less than about 0.03 microns. In some embodiments, the continuous synthetic fibers of the main filtration layer may have an average diameter of at least about 0.01 microns, at least about 0.03 microns, at least about 0.05 microns, at least about 0.1 microns (e.g., at least about 0.2 microns, at least about 0.3 microns, at least about 0.4 microns), at least about 0.5 microns, at least about 1.0 micron, at least about 5.0 microns, at least about 10.0 microns, or at least about 15.0 microns. Combinations of the above-noted ranges are also possible (e.g., between about 0.05 microns and 0.5 microns, between about 0.2 microns and 1.0 micron, between about 0.5 micron and 2.0 microns, between about 1.0 micron and 3.0 microns, between about 1.0 micron and 5.0 microns, etc.). Fiber diameters may be measured, for example, using scanning electron microscopy.

The main filtration layer(s) of the filter media may be formed of continuous synthetic fibers (e.g., meltblown fibers, meltspun fibers, spunbond fibers, electrospun fibers, centrifugal spun fibers, etc.) having a suitable average length. For example, in some embodiments, the continuous synthetic fibers of the main filtration layer may have an average length of at least about 5 cm, at least about 10 cm, at least about 15 cm, at least about 20 cm, at least about 50 cm, at least about 100 cm, at least about 200 cm, at least about 500 cm, at least about 700 cm, at least about 1000, at least about 1500 cm, at least about 2000 cm, at least about 2500 cm, at least about 5000 cm, at least about 10000 cm; and/or less than or equal to about 10000 cm, less than or equal to about 5000 cm, less than or equal to about 2500 cm, less than or equal to about 2000 cm, less than or equal to about 1000 cm, less than or equal to about 500 cm, or less than or equal to about 200 cm. Combinations of the above-referenced ranges are also possible (e.g., greater than or equal to about 100 cm and less than or equal to about 2500 cm). Other values of average fiber length are also possible.

The continuous synthetic fibers of the main filtration layer(s) may have a suitable average aspect ratio. For example, in some embodiments, continuous synthetic fibers in a main filtration layer may have an average aspect ratio between about 100 and about 1,000,000 or between about 1,000 and about 100,000.

In some embodiments, the main filtration layer(s) of filter media may include a relatively high percentage of continuous synthetic fibers, e.g., at least about 50 wt %, at least about 60 wt %, at least about 70 wt %, at least about 80 wt %, at least about 90 wt %, at least about 95 wt %, at least about 97 wt %, at least about 99 wt %, or 100 wt % continuous synthetic fibers (e.g., synthetic polymer meltblown fibers). Other percentages of continuous synthetic fibers within the main filtration layer may be possible.

In general, the continuous synthetic fibers in the main filtration layer(s) of the filter media may have any suitable composition. In some cases, the continuous synthetic fibers comprise a thermoplastic. Non-limiting examples of the continuous synthetic fibers include PVA (polyvinyl alcohol), polyester (e.g., polybutylene terephthalate, polybutylene naphthalate), polyethylene, polypropylene, acrylic, polyolefin, polyamides (e.g., nylon), rayon, polycarbonates, polyphenylene sulfides, polystyrenes, polybutylene terephthalate, and polyurethanes (e.g., thermoplastic polyurethanes), regenerated cellulose and combinations thereof. Optionally, the polymer(s) may contain fluorine atoms. Examples of such polymers include PVDF and PTFE. It should be appreciated that other appropriate continuous synthetic fibers may also be used. In some embodiments, the continuous synthetic fiber is chemically stable with hydraulic fluids for hydraulic applications. In some embodiments, the same type of continuous synthetic fibers that may be incorporated into the pre-filter and, as discussed above, may also be incorporated into the main filtration layer.

Alternatively, as discussed herein, the main filtration layer of the filter media may be formed of synthetic staple fibers. In some embodiments, the synthetic staple fibers of the main filtration layer may have an average diameter of less than about 30.0 microns, less than about 20.0 microns, less than about 15.0 microns, less than about 10.0 microns, less than about 5.0 microns, less than about 1.0 micron, less than about 0.5 microns, or less than about 0.2 microns. In some embodiments, the synthetic staple fibers of the main filtration layer may have an average diameter of at least about 0.2 microns, at least about 1.0 micron, at least about 5.0 microns, at least about 10.0 microns, at least about 15.0 microns, at least about 20.0 microns, or at least about 30.0 microns. Combinations of the above-noted ranges are also possible (e.g., between about 0.1 microns and 5.0 microns, between about 1.0 microns and 10.0 microns, etc.). Fiber diameters may be measured, for example, using scanning electron microscopy.

The main filtration layer(s) of the filter media may be formed of synthetic staple fibers having a suitable average length. In general, synthetic staple fibers may be characterized as being shorter than continuous synthetic fibers. For example, in some embodiments, the synthetic staple fibers of the main filtration layer may have an average length at least about 0.1 mm, at least about 0.5 mm, at least about 1.0 mm, at least about 1.5 mm, at least about 2.0 mm, at least about 3.0 mm, at least about 4.0 mm, at least about 5.0 mm, at least about 6.0 mm, at least about 7.0 mm, at least about 8.0 mm, at least about 9.0 mm, at least about 10.0 mm, at least about 12.0 mm, at least about 15.0 mm; and/or less than or equal to about 15.0 mm, less than or equal to about 12.0 mm, less than or equal to about 10.0 mm, less than or equal to about 5.0 mm, less than or equal to about 1.0 mm, less than or equal to about 0.5 mm, or less than or equal to about 0.1 mm.

In some embodiments, the main filtration layer(s) of filter media may include a suitable amount of synthetic staple fibers, e.g., at least about 50 wt %, at least about 60 wt %, at least about 70 wt %, at least about 80 wt %, at least about 90 wt %, at least about 95 wt %, at least about 97 wt %, at least about 99 wt %, or 100 wt % synthetic staple fibers. Other percentages of synthetic staple fibers within the main filtration layer may be possible.

Synthetic staple fibers in the main filtration layer(s) of the filter media may have any suitable composition. In general, synthetic staple fibers may include compositions similar to continuous synthetic fibers, yet other characteristics may vary (e.g., dimensions). For example, synthetic staple fibers may include PVA (polyvinyl alcohol), polyester (e.g., polybutylene terephthalate, polybutylene naphthalate), polyethylene, polypropylene, acrylic, polyolefin, polyamides (e.g., nylon), rayon, polycarbonates, polyphenylene sulfides, polystyrenes, polybutylene terephthalate, and polyurethanes (e.g., thermoplastic polyurethanes), regenerated cellulose, PVDF, PTFE and combinations thereof. In some embodiments, such synthetic staple fibers may be incorporated into a pre-filter and, as discussed above, may also be incorporated into the main filtration layer.

In some cases, the main filtration layer(s) may include fibers other than continuous synthetic fibers or synthetic staple fibers. For example, binder fibers and/or bicomponent fibers (e.g., bicomponent binder fibers) may be employed. In some embodiments, the main filtration layer(s) may include non-synthetic fibers. As discussed above, the main filtration layer(s) of the filter media may include synthetic polymer fibers that have an appropriate shrinkage temperature. The shrinkage temperature of the synthetic polymer fibers, as described above, is an observed temperature at which a fiber web, where 100% of the fibers are the synthetic polymer fibers, exhibits a decrease in area of greater than or equal to 5% from an initial area, when subject to an incremental increase in temperature (i.e., 1 degree C. per minute) from ambient temperature.

The synthetic polymer fibers incorporated within the filtration layer(s) of the filter media may have a suitable shrinkage temperature. In some embodiments, the shrinkage temperature of the synthetic polymer fibers may be greater than or equal to about 40 degrees C., greater than or equal to about 50 degrees C., greater than or equal to about 100 degrees C., greater than or equal to about 150 degrees C., greater than or equal to about 200 degrees C., greater than or equal to about 250 degrees C., greater than or equal to about 300 degrees C.; and/or less than or equal to about 300 degrees C., less than or equal to about 250 degrees C., less than or equal to about 230 degrees C., less than or equal to about 200 degrees C., less than or equal to about 150 degrees C., less than or equal to about 100 degrees C., or less than or equal to about 50 degrees C. Combinations of the above-referenced ranges are also possible (e.g., greater than or equal to about 40 degrees C. and less than or equal to about 300 degrees C.).

As described herein, a suitable coating may be applied to the main filtration layer(s). In some embodiments, the cure temperature of the coating may be less than or equal to about 300 degrees C., less than or equal to about 250 degrees C., less than or equal to about 230 degrees C., less than or equal to about 200 degrees C., less than or equal to about 150 degrees C., less than or equal to about 100 degrees C., less than or equal to about 50 degrees C., less than or equal to about 20 degrees C., less than or equal to about 10 degrees C.; and/or at least about 10 degrees C., at least about 20 degrees C., at least about 50 degrees C., at least about 100 degrees C., at least about 150 degrees C., at least about 200 degrees C., at least about 230 degrees C., at least about 250 degrees C., or at least about 300 degrees C. Combinations of the above-noted ranges are also possible (e.g., at least 10 degrees C. and less than or equal to about 300 degrees C.). In some embodiments, the coating applied to the main filtration layer may cure at room/ambient temperature, without requiring a temperature increase of the surrounding environment.

In various embodiments, the coating applied to the main filtration layer(s) of the filter media has a cure temperature that is less than a shrinkage temperature of the synthetic polymer fibers of the main filtration layer(s). In some embodiments, the cure temperature of the coating is less than the shrinkage temperature of the synthetic polymer fibers by greater than or equal to about 1%, greater than or equal to about 2%, greater than or equal to about 3%, greater than or equal to about 4%, greater than or equal to about 5%, greater than or equal to about 10%, greater than or equal to about 15%, greater than or equal to about 20%, greater than or equal to about 25%, greater than or equal to about 30%; or less than or equal to about 30%, less than or equal to about 25%, less than or equal to about 20%, less than or equal to about 15%, less than or equal to about 10%, less than or equal to about 5%, less than or equal to about 3%, less than or equal to about 1%, or combinations thereof (e.g., between 1% and 30%, between 1% and 25%, between 5% and 20%).

The main filtration layer(s) of the filter media can generally have any suitable thickness. In some embodiments, the main filtration layer is at least about 5 microns (e.g. at least about 10 microns, at least about 20 microns, at least about 30 microns, at least about 50 microns) thick, and/or less than or equal to about 500 microns (e.g., less than or equal to about 400 microns, less than or equal to about 200 microns, less than or equal to about 180 microns, less than or equal to about 150 microns) thick. Combinations of the above-referenced ranges are also possible (e.g., at least about 5 microns thick and less than or equal to about 500 microns thick).

Thickness, as referred to herein, is determined according to TAPPI T411 using an appropriate caliper gauge (e.g., a Model 200-A electronic microgauge manufactured by Emveco, tested at 1.5 psi). In some cases, if the thickness of a layer cannot be determined using an appropriate caliper gauge, visual techniques such as scanning electron microscopy in cross-section view can be used.

The basis weight of the main filtration layer(s) can typically be selected as desired. In some embodiments, the basis weight of the main filtration layer is at least about 1 g/m² (e.g., at least about 10 g/m², at least about 15 g/m², at least about 25 g/m²), and/or less than about 100 g/m² (less than about 90 g/m², less than about 75 g/m², less than about 40 g/m², less than about 30 g/m², less than about 25 g/m², or less than about 20 g/m²). Combinations of the above-referenced ranges are also possible (e.g., from about 1 g/m² to about 100 g/m²).

The mean flow pore size of the main filtration layer(s) of the filter media can vary as desired. For example, the main filtration layer, after coating (e.g., impregnation or saturation therein and/or application on the outer surface), can have a mean flow pore size that may be less than or equal to about 50 microns, less than or equal to about 30 microns, less than or equal to about 20 microns, less than or equal to about 10 microns, less than or equal to about 8 microns, less than or equal to about 5 microns, less than or equal to about 1 micron, less than or equal to about 0.5 microns, less than or equal to about 0.1 micron; and/or at least about 0.1 micron, at least about 0.5 microns, at least about 1 micron, at least about 5 microns, at least about 10 microns, at least about 20 microns, at least about 30 microns, or at least about 50 microns. Combinations of the above-noted limits are possible (e.g., between about 0.05 microns and about 50 microns, between about 0.1 microns and about 50 microns, between about 0.5 microns and about 50 microns, between about 1 micron and about 50 microns, between about 0.5 microns and about 30 microns, between about 1 micron and about 30 microns, between about 2 microns and about 25 microns, between about 5 microns and about 50 microns, between about 10 microns and about 30 microns, between about 10 microns and about 20 microns, between 5 microns and 15 microns, between about 8 microns and about 12 microns, between about 1 micron and about 5 microns, between about 5 microns and about 9 microns, or between about 13 microns and about 17 microns), as well as values outside of these ranges. The mean flow pore size may be measured according to methods described above.

The pores of the main filtration layer(s) (e.g., coated portion) of the filter media may exhibit a relatively tight distribution. The standard deviation of the mean flow pore size of at least a portion of or the entire main filtration layer (e.g., coated portion of the main filtration layer(s)) may also fall within a suitable range. In some embodiments, the standard deviation of the mean flow pore size of at least a portion of or the entire main filtration layer after coating may be less than or equal to about 30 microns, less than or equal to about 20 microns, less than or equal to about 15 microns, less than or equal to about 12 microns, less than or equal to about 10 microns, less than or equal to about 8 microns, less than or equal to about 6 microns, less than or equal to about 4 microns, less than or equal to about 2 microns; and/or at least about 2 microns, at least about 4 microns, at least about 8 microns, at least about 10 microns, or at least about 15 microns. Combinations of the above-noted limits are possible. For example, the standard deviation of the mean flow pore size of at least a portion of or the entire main filtration layer after coating may be between about 1 micron and about 30 microns, between about 10 micron and about 30 microns, between about 1 micron and about 15 microns, between about 2 microns and about 10 microns, or between about 4 micron and about 8 microns. Values outside of these ranges are also possible.

The mean flow pore size and the standard deviation for at least a portion (e.g., coated portion) or the entirety of the main filtration layer(s) of the filter media, as described herein, may be appropriately measured. For example, any of the above mean flow pore size and the standard deviation ranges may be measured for a portion of one or more layers of a filter media that includes an area of the outer surface of greater than about 2 cm×2 cm, greater than about 5 cm×5 cm, greater than about 10 cm×10 cm, greater than about 15 cm×15 cm, greater than about 20 cm×20 cm, greater than about 30 cm×30 cm, and/or less than about 30 cm×30 cm, less about 20 cm×20 cm, less than about 15 cm×15 cm, less than about 10 cm×10 cm, less than about 5 cm×5 cm, less than about 2 cm×2 cm. Combinations of the above-referenced ranges are also possible. For example, any of the above mean flow pore size and the standard deviation ranges may be measured for a portion of one or more layers of a filter media that includes an area of the outer surface of between about 2 cm×2 cm and about 30 cm×30 cm, between about 5 cm×5 cm and about 20 cm×20 cm, or between about 10 cm×10 cm and about 15 cm×15 cm.

Any of the above noted mean flow pore size and the standard deviation ranges may be measured for a portion (e.g., coated portion) of one or more layers of a filter media that includes an area of greater than about 20% of the overall area of the outer surface of the layer(s), greater than about 30% of the overall area of the outer surface of the layer(s), greater than about 40% of the overall area of the outer surface of the layer(s), greater than about 50% of the overall area of the outer surface of the layer(s) (i.e., a majority of the area of the outer surface of the layer(s)), greater than about 60% of the overall area of the outer surface of the layer(s), greater than about 70% of the overall area of the outer surface of the layer(s), greater than about 80% of the overall area of the outer surface of the layer(s), greater than about 90% of the overall area of the outer surface of the layer(s), the entirety of the area of the outer surface of the layer(s), etc.

The air permeability of the main filtration layer(s) of the filter media can also vary as desired. In general, the main filtration layer may exhibit a relatively tight pore structure, and hence, less permeability, in comparison to the pre-filter. In some embodiments, the main filtration layer has an air permeability of less than about 500 cfm/sf (e.g., less than about 250 cfm/sf, less than about 200 cfm/sf), and/or at least about 20 cfm/sf (e.g., at least about 50 cfm/sf, at least about 100 cfm/sf). Combinations of the above-referenced ranges are also possible (e.g., from about 0.5 cfm/sf to about 500 cfm/sf).

The main filtration layer(s) may exhibit a suitable pressure drop, as measured with clean hydraulic fluid. As opposed to the multipass filter test method described above where fluid filled with dust particulates is used to measure dust holding capacity and/or efficiency, pressure drop as used herein is measured using a flatsheet test determined according to ISO 3968, with clean hydraulic fluid at 15 cSt having a face velocity of 0.67 cm/s.

In some embodiments, the main filtration layer may have a relatively small pressure drop. For instance, in some embodiments, the pressure drop of the main filtration layer may be less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 4.5 kPa, or less than or equal to about 1 kPa. In some instances, the pressure drop of the main filtration layer may be greater than or equal to about 0.05 kPa, greater than or equal to about 0.1 kPa, greater than or equal to about 0.5 kPa, greater than or equal to about 1 kPa, greater than or equal to about 5 kPa, greater than or equal to about 10 kPa, greater than or equal to about 20 kPa, greater than or equal to about 30 kPa, greater than or equal to about 40 kPa, or greater than or equal to about 50 kPa. Combinations of the above-referenced ranges are also possible (e.g., greater than or equal to about 0.05 kPa and less than or equal to about 80 kPa, greater than or equal to about 0.1 kPa and less than or equal to about 50 kPa). In various embodiments, the pressure drop of the overall filter media may be substantially similar to the pressure drop of the main filtration layer of the filter media.

As discussed herein, the main filtration layer(s) may include a coating (e.g., binder resin, binder fibers) that impregnates, saturates or otherwise coats the fibers of the main filtration layer(s). Application of this coating may provide the fiber web(s) with an enhanced degree of mechanical strength, allowing for the size and structure of the pores within the filter media to be suitably maintained. Such mechanical support may be helpful to resist collapse and/or closure of the pores, which may allow the filter media to exhibit a desired level of permeability and pressure drop.

The coating may make up a suitable weight percentage of the main filtration layer. In some embodiments, the weight percentage of coating within the main filtration layer(s) is greater than 1%, greater than 2%, greater than 3%, greater than about 5%, greater than about 10%, greater than about 15%, greater than about 20%, greater than about 25%, greater than about 30%, greater than about 35%, greater than about 40%, greater than about 45%, greater than about 50%, greater than about 55%, or greater than about 60% relative to the total amount of dry solids. In some embodiments, the weight percentage of coating within the main filtration layer is less than about 60%, less than about 55%, less than about 50%, less than about 45%, less than about 40%, less than about 35%, less than about 30%, less than about 25%, less than about 20%, less than about 15%, less than about 10%, or less than about 5% relative to the total amount of dry solids. Combinations of the above-referenced ranges are also possible (e.g., between 2% and 60%, between 5% and 50% relative to the total amount of dry solids).

The coating may coat at least a portion of area of the outer surface of the main filtration layer(s). For example, the coating may coat greater than 50% (e.g., a majority), greater than 60%, greater than 70%, greater than 75%, greater than 80%, greater than 85%, greater than 90%, greater than 95%, or greater than 99% (e.g., approximately 100%, substantially all or the entirety) of the area of the outer surface of the main filtration layer(s). Or, the coating may coat less than 100%, less than 99%, less than 95%, less than 90%, less than 80%, less than 75%, less than 70%, or less than 60% of the area of the outer surface of the main filtration layer(s). Combinations of the above-noted ranges are possible. For example, the coating may coat between 50% and 100%, between 50% and 95%, or between 60% and 95% of the area of the outer surface of the main filtration layer(s).

Various types of coating(s) that may be incorporated within the main filtration layer(s) and/or other portions of the overall filter media are further described below. For example, in some embodiments, methods and materials used for coating the main filtration layer as described herein may also be used to coat one or more layers of the pre-filter.

The coating may be added to the fibers in any suitable manner including, for example, in a wet state or a non-wet state. In some embodiments, the coating coats the fibers and is used to adhere fibers to each other to facilitate adhesion between the fibers.

In general, the coating (e.g., binder resin) applied to the main filtration layer may have any suitable composition.

A suitable binder resin may comprise a thermoplastic, a thermoset, or a combination thereof. For example, the binder resin may include one or more of the following resins: thermoplastic resin, thermoset resin, acrylic, acrylic resin (e.g., acrylic thermoset resin), epoxy, vinyl acrylic, latex emulsion, nitrile, styrene, styrene-acrylic, styrene butadiene rubber, polyvinyl chloride, ethylene vinyl chloride, polyolefin, polyvinyl halide, polyvinyl ester, polyvinyl ether, polyvinyl sulfate, polyvinyl phosphate, polyvinyl amine, polyamide, polyimide, polyoxidiazole, polytriazol, polycarbodiimide, polysulfone, polycarbonate, polyether, polyarylene oxide, polyester, polyarylate, phenolics, phenolic resin, phenol-formaldehyde resin, polyacrylamide, epichlorohydrin, melamine-formaldehyde resin, formaldehyde-urea, vinyl acetate, ethylene vinyl acetate, polyvinyl acetate, ethyl-vinyl acetate copolymer, and/or other suitable compositions. The resin may be anionic, cationic, or non-ionic in nature. The resin may be provided as an aqueous or non-aqueous solvent-based system.

In some embodiments, the coating includes one or more polymeric resins, for example, polyacrylates, polyurethanes, polycarbonates, polyesters, polyterpenes, furan polymers (e.g., polyfurfural alcohol), epoxies, dicyandiamide, 2-methyl imidazole amines, mercaptan (thiol), phenolic systems using resoles and/or novolacs, terpene phenolics, bismaleimides, cyanate esters, ethylol melamines, methylol ureas, methylol adducts of organic bases, guanidine guanylureas, biurets, triurets, polyphenol, acrylic emulsions, acrylic copolymer binder resins, saturated resins, unsaturated resins, or other compositions.

The coating of the main filtration layer may employ any suitable solvent, such as solvent based resins (e.g., thermoplastic, thermoset) or water-based resins. In some embodiments, the solvent of the coating may include, for instance, acetone, water, methanol, aliphatic alcohol (e.g., ethanol, N-propanol, iso-propanol, N-butyl alcohol, iso-butyl alcohol, branched alkyl alcohol, unbranched alkyl alcohol, ethylene glycol, diethylene glycol, higher homologs of diethylene glycol, glycerine, pentaerythritol, diacetone alcohol, etc.), aromatic alcohol (e.g., phenol, benzyl alcohol, alkyl-substituted benzyl alcohol, o-cresol, m-cresol, p-cresol, catechol, alkyl-substituted catechol, resorcinol, alkyl-substituted resorcinol, etc.), aromatic ketone, aliphatic ketone (e.g., acetone, methyl ethyl ketone, cyclohexanone, diethyl ketone, diisopropyl ketone, methyl iso-butyl ketone, methyl amyl ketone, methyl iso-amyl ketone, etc.), ester (e.g., ethyl acetate, methyl acetate, butyl acetate, iso-butyl acetate, amyl acetate, iso-amyl acetate, benzyl acetate, methyl lactate, ethyl lactate, methyl benzoate, dibasic esters, mono-alkyl esters of adipic/glutaric/succinic acid, di-alkyl esters of adipic/glutaric/succinic acid, ethyl benzoate, iso-propyl benzoate, ethyleneglycol ethylether acetate, ethyleneglycol methylether acetate, diethyleneglycol ethylether acetate, diethyleneglycol methylether acetate, propyleneglycol methylether acetate, propyleneglycol ethylether acetate, ethoxyethyl propionate, phenoxyethyl acetate, tripropyleneglycol diacetate, hexanediol acetate, etc.), reactive diluent (e.g., acrylate, methacrylate, etc.), nitrile solvents (e.g., acetonitrile, propionitrile, butyronitrile, etc.), ether (e.g., dimethyl ether, diethyl ether, di-iso-propyl ether, tetrahydrofuran, dioxanes, diphenyl ether, dimethyoxyethane, glycol ether, half ether, ethyleneglycol alkyl ether, diethyleneglycol dialkyl ether, diethyleneglycol monoalkyl ether, propylene glycol dialkyl ether, propylene glycol monoalkyl ether, dipropyleneglycol dialkyl ether, dipropyleneglycol monoalkyl ether, etc.), chlorinated solvent (e.g., chloroform, dichloromethane, dichloroethane, chlorobenxene, P-chloro benzotrifluoride, etc.), aliphatic solvent (e.g., pentane, hexane, heptane, octane, branched isomer, higher homologs, 2-ethylhexane, 2,2,4-trimethylpentane, ligroin, hydrocarbon mixtures, petroleum ether, mineral spirits, white spirits, naptha, terpene, monoterpene, geraniol, limonene, terpineol, sesquiterpenes, humulene, farnesene, farnesol, diterpene, cafestol, kahweol, cembrene, turpentine, terpeneoid), aromatic solvent (e.g., benzene, toluene, xylene, mesitylene, ethyl benzene, pyridine, alkyl-substituted pyridine, etc.), amide solvent (e.g., formamide, methyl formamide, dimethyl formamide, acetamide, methylacetamide, dimethyl acetamide, etc.), lactam solvent (e.g., pyrrolidone, pyrolidinone, N-methyl pyrrolidone, N-methyl pyrolidinone, alkyl N-substituted pyrolidone, etc.), sulfoxide, dimethyl sulfoxide, sulfone solvent, dimethyl sulfone, acid anhydride solvent, acetic acid, acetic anhydride, propionic acid, propionic anhydride, carbon dioxide, carbon disulfide, or others.

In some embodiments, a binder resin used to form a coating on the main filtration layer in accordance with the present disclosure may be a water-based resin (e.g., a water-based polymeric resin). Non-limiting examples of water-based polymer resins include acrylic resins, styrene resins, polyvinyl alcohol resins, and vinyl acetate resins, and combinations thereof. It should be appreciated that any suitable water-based polymeric resin may be utilized. In other embodiments, the binder resin used to form a coating on the main filtration layer may be a non-aqueous solvent-based resin (e.g., an organic solvent-based polymeric resin), e.g., including one or more of the oganic solvents described herein. In some embodiments, resins including mixtures of water and organic solvents (e.g., water-miscible organic solvents) can be used. Combinations of aqueous-based and non-aqueous based resins are also possible.

In some embodiments, the main filtration layer may be coated with a resin (e.g., a pre-cured resin) that includes at least two components (e.g., a first component and a second component). As discussed above, various components in the resin may undergo a chemical reaction with one another (e.g., upon curing) to form a reaction product. Additionally, in some cases, a component in the resin may react with itself. For instance, a component in the form of a monomer (e.g., an epoxy monomer) may polymerize to form a homopolymer (e.g., polyepoxide). In some cases, a component may react with another component in the resin, e.g., to form a copolymer. For example, a first monomer (e.g., an epoxy monomer) in the resin may react with another component in the resin, such as a second monomer or a polymer (e.g., a copolyester), to form a branched polymer, a linear polymer, a copolymer, a crosslinked network, or combinations thereof.

In some embodiments, a component in the resin may undergo more than one chemical reaction. For instance, a component in the resin may react with itself and with a second component in the resin. In one example, a monomer (e.g., an epoxy monomer) in the resin may react with itself to form an oligomer or polymer, which may react with a polymer in the resin to form a copolymer. In some cases, more than one chemical reaction may occur simultaneously and/or sequentially. In some embodiments, after the formation of a reaction product in the resin (e.g., by reaction of a first component with itself, or by reaction of a first component with a second component), the reaction product may undergo a chemical reaction. For example, a copolymer (e.g., a reaction product of a first component such as a copolyester and second component such as an epoxy monomer) may react with a polymer (e.g., a third component, or more of the first component) to form a polymer network (e.g., a cured or crosslinked network). In certain cases, a reaction product in the resin may react with itself to form a longer chained polymer that may be branched or unbranched. For example, an oligomer (e.g., a reaction product of an epoxy monomer) may react with itself to form a polymer. A reaction product may also react with another reaction product in the resin. For instance, a first polymer (e.g., a reaction product of epoxy) may react with a second polymer (e.g., a reaction product of a polymer and a monomer) to form a copolymer.

In some embodiments, a reaction product in the resin may undergo more than one chemical reaction. For instance, a reaction product in the coating may react with itself and with another component in the coating. In one example, a first reaction product (e.g., a polymer such as a polyepoxide) may react with a second polymer in the resin to form a second reaction product (e.g., a copolymer). The first reaction product may optionally undergo another reaction, e.g., crosslinking with other first reaction products or second reaction products in the resin. When more than one chemical reaction takes place, the reactions may occur simultaneously and/or sequentially.

In other embodiments, a first component in the resin may be designed to react with itself but not another component (e.g., a second component) in the resin. Additionally, a second component may be designed to react with itself and not with the first component. Such components can be designed by tailoring the functional groups of the components as known to those of ordinary skill in the art. The two types of polymer chains formed may be intertwined with one another, but not covalently coupled, in the resulting coating.

In some embodiments, a component and/or reaction product in the resin may react to form a particular type of copolymer. Exemplary types of copolymers include alternating copolymers, periodic copolymers, random copolymers, dendrimer, terpolymers, quaterpolymers, graft copolymers, linear copolymer, and block copolymers.

In some embodiments, in general, a fiber web (e.g., main filtration layer) coated with a resin that includes at least two components as described herein may have enhanced mechanical and/or filtration properties compared to a fiber web coated with a resin that includes only a single component (e.g., a first component or a second component). In one example, a fiber web coated with a resin that includes a first component (e.g., a polymer) and a second component (e.g., an epoxy) may be stronger and/or more flexible (e.g., have higher elongation) than a fiber web coated with a resin that only includes one of the components (e.g., an epoxy resin). Other advantages are described herein.

In some embodiments, the first component is a reactive polymer (e.g., a linear polymer, a copolymer). The polymer may be a particular type (e.g., polyester) or in a particular class (e.g., thermoplastic). Non-limiting examples of types of polymers that may be suitable as a first component include polyethers, polyarylethers, polyalkyethers, polysulfone, polyarylsulfone, polyvinylchloride, polyether ether ketones, polyether ketones, polyethersulfones, polyolefins, rubbers, polystyrenes, styrene acrylates, styrene maleic anhydrides, polyvinyl alcohols, polyvinyl acetates, polyvinyl alcohol esters, polyvinyl amines and ammonium salts of polyvinylamines, polyvinyl amides and partially hydrolyzed polyvinylamides and ammonium salts of partially hydrolyzed vinylamides, polyacrylonitriles, polyparalenes, polyphenylenes, polyglycolides, poly(lactic-co-glycolic acid), polylactic acid, polycaprolactam, poly(glycolide-co-caprolactone), poly (glycolide-co-trimethylene carbonate), polysiloxanes, polyarylates, polyaminoacids, polylactams, polyhydantoins, polyketones, polyureas, polystyrene sulfonates, lignins, polyphosphazines, polyethylene chlorinates, polyetherimide, cellulose acetate, carboxymethyl cellulose, alkyds, polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof. Exemplary classes of polymers include thermoplastics and thermosets. Other types and classes of polymers are also possible.

In some embodiments, the first component is a copolymer. The copolymer may be, for example, an alternating copolymer, a periodic copolymer, a random copolymer, a dendrimer, a terpolymer, a quaterpolymer, a graft copolymer, a linear copolymer, or a block copolymer.

In some embodiments, the first component (e.g., a polymer) may have certain properties, such as number of repeat units (n), number average molecular weight (Mₙ), glass transition temperature (T_{g}), hydroxyl (OH) number, and/or acid number. In certain embodiments, the number of repeat units and number average molecular weight may be selected to impart desirable properties (e.g., enhanced solubility in the resin or resin solution, add flexibility and/or strength to the fiber web). For example, a first component with a relatively high number of repeat units and Mₙ may, in some embodiments, produce a more flexible and stronger (e.g., less brittle) coating than a first component with a relatively low number of repeat units and/or Mₙ. The glass transition temperature of the first component may be selected to enhance certain mechanical properties of the fiber web, such as elongation, strength, flexibility, and/or resistance to deformation.

In certain embodiments in which the first component (e.g., a polymer) includes hydroxyl (—OH) groups and acid groups, the OH number and acid number may be selected to impart reactive functionality for a chemical reaction. In some instances, the OH number and acid number of the first component may influence the number of chemical reactions that the first component (e.g., polymer) undergoes and/or the type of reaction products (e.g., a long chain copolymer, crosslinked network) that are formed. In turn, the number of chemical reactions and the type of reaction products in the coating may influence the mechanical properties of the fiber web. In one example, a first component with a relatively low OH number and/or acid number may undergo fewer chemical reactions than a first component with a relatively high OH number and/or acid number. A first component with a relatively low OH number and/or acid number may enhance the flexibility of the fiber web, whereas a first component with a relatively high OH number and/or acid number may produce a relatively more brittle coating on the fiber web.

In some instance, the first component (e.g., a polymer) may be selected based on a single property. For example, the first component may be selected based on its glass transition temperature. In other instances, the first component may be selected based on more than one property (e.g., T_{g}, Mₙ, and OH number). In certain embodiments, the criteria for selecting a first component may vary based on certain factors, such as other components in the resin and the intended application of the fiber web.

In some embodiments, the first component may be selected based on its number average molecular weight. For instance, the number average molecular weight of the first component may be greater than or equal to about 1,000 g/mol, greater than or equal to about 3,000 g/mol, greater than or equal to about 5,000 g/mol, greater than or equal to about 10,000 g/mol, greater than or equal to about 15,000 g/mol, greater than or equal to about 20,000 g/mol, about 30,000 g/mol, or greater than or equal to about 40,000 g/mol. In some instances, the number average molecular weight of the first component may be less than or equal to about 50,000 g/mol, less than or equal to about 40,000 g/mol, less than or equal to about 30,000 g/mol, less than or equal to about 25,000 g/mol, less than or equal to about 20,000 g/mol, less than or equal to about 15,000 g/mol, less than or equal to about 10,000 g/mol, or less than or equal to about 5,000 g/mol. Combinations of the above-referenced ranges are also possible (e.g., greater than or equal to about 3,000 g/mol and less than or equal to about 40,000 g/mol). Other values of the number average molecular weight of the first component are also possible. The number average molecular weight may be determined using gel permeation chromatography (GPC), nuclear magnetic resonance spectrometry (NMR), laser light scattering, intrinsic viscosity, vapor pressure osmometry, small angle neutron scattering, laser desorption ionization mass spectrometry, matrix assisted laser desorption ionization mass spectrometry (MALDI MS), electrospray mass spectrometry or may be obtained from a manufacturer's specifications. Unless otherwise indicated the values of number average molecular weight described herein are determined by gel permeation chromatography (GPC).

In some embodiments, the first component may be selected based on its glass transition temperature (T_{g}). For instance, in some embodiments, the glass transition temperature of the first component may be greater than or equal to about −30° C., greater than or equal to about −15° C., greater than or equal to about 0° C., greater than or equal to about 15° C., greater than or equal to about 30° C., greater than or equal to about 45° C., greater than or equal to about 60° C., greater than or equal to about 75° C., or greater than or equal to about 90° C. In some instances, the glass transition temperature of the first component may be less than or equal to about 120° C., less than or equal to about 100° C., less than or equal to about 80° C., less than or equal to about 60° C., less than or equal to about 40° C., less than or equal to about 20° C., less than or equal to about 0° C., or less than or equal to about −20° C. Combinations of the above-referenced ranges are also possible (e.g., greater than or equal to about 15° C. and less than or equal to about 80° C.). Other values of glass transition temperature of the first component are also possible. The glass transition temperature of the first component may be determined using differential scanning calorimetry (DSC), thermomechanical analysis (TMA), dynamic mechanical analysis (DMA), or may be obtained from a manufacturer's specifications. Unless indicated otherwise, the values of glass transition temperature described herein are determined by differential scanning calorimetry (DSC).

In some embodiments, the first component may be selected based on its hydroxyl (OH) number. The OH number is the number of milligrams of potassium hydroxide equivalent, in number of moles, to the hydroxyl content in one gram of the component. The OH number of the first component may be, for example, greater than or equal to about 0, greater than or equal to about 2, greater than or equal to about 5, greater than or equal to about 10, greater than or equal to about 30, greater than or equal to about 50, greater than or equal to about 70, or greater than or equal to about 90. In some instances, the OH number of the first component may be less than or equal to about 100, less than or equal to about 80, less than or equal to about 60, less than or equal to about 40, less than or equal to about 20, or less than or equal to about 10. Combinations of the above-referenced ranges are also possible (e.g., greater than or equal to about 2 and less than or equal to about 60). Other values of the OH number of the first component are also possible. The OH number may be determined by acetylating the hydroxyls with excess acetic anhydride and titrating the acetic acid remaining after by the acetylation reaction.

In some embodiments, the first component may be selected based on its acid number. The acid number is the number of milligrams of potassium hydroxide equivalent, in number of moles, to the free acid content in one gram of the component. The acid number of the first component may be, for example, greater than or equal to about 0, greater than or equal to about 1, greater than or equal to about 3, greater than or equal to about 5, greater than or equal to about 10, greater than or equal to about 15, or greater than or equal to about 20. In some instances, the acid number of the first component may be less than or equal to about 25, less than or equal to about 20, less than or equal to about 15, less than or equal to about 10, less than or equal to about 5, or less than or equal to about 3. Combinations of the above-referenced ranges are also possible (e.g., greater than or equal to about 0 and less than or equal to about 10). Other values of the acid number of the first component are also possible. The acid number may be determined by titrating the acid to the equivalence point with potassium hydroxide.

In some embodiments, the weight percentage of the first component in the resin may be selected as desired. For instance, the weight percentage of the first component in the resin may be greater than or equal to about 1 wt %, greater than or equal to about 15 wt %, greater than or equal to about 20 wt %, greater than or equal to about 40 wt %, greater than or equal to about 55 wt %, greater than or equal to about 70 wt %, or greater than or equal to about 85 wt %. In some instances, the weight percentage of the first component in the resin may be less than or equal to about 99 wt %, less than or equal to about 90 wt %, less than or equal to about 75 wt %, less than or equal to about 60 wt %, less than or equal to about 45 wt %, less than or equal to about 30 wt %, or less than or equal to about 15 wt %. Combinations of the above-referenced ranges are also possible (e.g., greater than or equal to about 20 wt % and less than or equal to about 99 wt %). Other values of weight percentage of the first component in the resin are also possible. The weight percentage of the first component in the resin is based on the dry resin solids and can be determined prior to coating the fiber web.

As described herein, a resin that forms a coating on a fiber web (e.g., main filtration layer) may include a second component. The second component may be a reactive entity such as a polymerizable molecule. In some embodiments, the second component may have fewer than 5 to 20 repeat units (e.g., an oligomer) or no repeat units (e.g., a monomer). For example, the second component may include less than or equal to 20, less than or equal to 15, less than or equal to 10, less than or equal to 5, less than or equal to 3, or less than or equal to 2 repeat units. The second component may include one or more reactive functional groups which can allow the second component to undergo a chemical reaction to form a larger molecule (e.g., a polymer). Non-limiting examples of reactive functional groups include hydroxyl groups, carboxyl groups, amino groups, mercaptan groups, acrylate groups, oxirane groups, bismaleimide groups, isocyanate, methylol groups, alkoxymethylalol groups, and ester groups. In certain embodiments, the second component is capable of undergoing a chemical reaction (e.g., with itself and/or with a first component) to form an oligomer, a polymer, a linear polymer, a branched polymer, a copolymer, a crosslinked network, and/or a cured network.

In some embodiments, the second component may be characterized as a component that is part of a cure system. For example, the cure system may be a formulated resin system (e.g., thermoset resin system) including a second component in the form of a monomer (e.g., epoxy). Other components of the cure system may optionally be present in the resin formulations described herein. For example, in some cases, one or more initiators (e.g., triphenyl phosphine, dicyandiamide and 2-methylimidazole for an epoxy cure system) may be present. In certain cases, one or more reactive curatives (e.g., carboxylic acid monomers, carboxylic acid oligomers, carboxylic acid polymers, phenolic monomers, phenolic oligomers, phenolic polymers, amine curative agents, thiol curative agents, diamines, dithiols, polyimides, amidoamines, agents that are reactive with epoxy) may be present. In some embodiments, an initiator is required for chemical reactivity of the second component. In other cases, an initiator is not required but may accelerate the reaction rate for a reaction involving the second component.

Non-limiting examples of cure systems include epoxies, terpene phenolics, bismaleimides, cyanate esters, aminoplasts, methylol melamine, isocyanate resins, methylol urea, methylol adducts of organic bases, such as dicyandiamide, guanidine guanylurea, biuret, triuret, etc., and combinations thereof. Accordingly, examples of suitable second components may include mono-, di, tri, etc.-epoxides, poly-epoxides, terpene phenolics, bismaleimides, cyanate esters, methylol melamines, methylol ureas, isocyanate resins, methylol adducts of organic bases such as dicyandiamide, guanidine, guanylurea, biuret, triuret, etc., and combinations thereof. Exemplary optional initiators include dicyandiamide, 2-methylimidazole, mercaptan, hexamethylenetetramine, triphenylphosphine, and combinations thereof.

In some embodiments, the second component may have a certain number average molecular weight. For instance, the second component may have a number average molecular weight of less than or equal to about 3,000 g/mol, less than or equal to about 2,000 g/mol, less than or equal to about 1,000 g/mol, less than or equal to about 500 g/mol, less than or equal to about 250 g/mol, or less than or equal to about 100 g/mol. In some instances, the second component may have a number average molecular weight of greater than or equal to about 20 g/mol, greater than or equal to about 100 g/mol, greater than or equal to about 500 g/mol, greater than or equal to about 1,000 g/mol, or greater than or equal to about 2,000 g/mol. Combinations of the above-referenced ranges are also possible (e.g., greater than or equal to about 20 g/mol and less than or equal to about 3,000 g/mol). Other values of the number average molecular weight of the second component are also possible. The number average molecular weight may be determined as described above. The particular method used may depend on the type of second component being measured.

In some embodiments, the weight percentage of the second component in the resin may be selected as desired. For instance, the weight percentage of the second component in the resin may be greater than or equal to about 1 wt %, greater than or equal to about 10 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the second component in the resin may be less than or equal to about 99 wt %, less than or equal to about 80 wt %, less than or equal to about 60 wt %, less than or equal to about 45 wt %, less than or equal to about 30 wt %, less than or equal to about 15 wt %, or less than or equal to about 5 wt %. Combinations of the above-referenced ranges are also possible (e.g., greater than or equal to about 1 wt % and less than or equal to about 60 wt %). Other values of weight percentage of the second component in the resin are also possible. The weight percentage of the second component in the resin is based on the percentage of the second component in the dry resin solids and can be determined prior to coating the fiber web.

For a main filtration layer that is coated with a resin that includes at least two components (e.g., a first component and a second component), the ratio of a first component (e.g., polymer) to a second component (e.g., monomer or oligomer) in the resin may be selected to impart desirable properties (e.g., mechanical properties, chemical reactivity, etc.). For instance, the ratio of a first component to a second component in the resin may be greater than or equal to about 0.01:1, greater than or equal to about 0.1:1, greater than or equal to about 1:1, greater than or equal to about 10:1, greater than or equal to about 20:1, greater than or equal to about 40:1, greater than or equal to about 60:1, or greater than or equal to about 80:1. In some instances, the ratio of a first component to a second component may be less than or equal to about 99:1, less than or equal to about 85:1, less than or equal to about 70:1, less than or equal to about 55:1, less than or equal to about 40:1, less than or equal to about 20:1, or less than or equal to about 5:1. Combinations of the above-referenced ranges are also possible (e.g., greater than or equal to about 1:1 and less than or equal to about 99:1). Other values of ratios of a first component to a second component are also possible. The ratio of a first component to a second component is based on the weight percentage of a first component in the resin to the weight percentage of a second component in the resin.

In some instances, the solvent of a resin may include a reactive diluent. For example, a solvent such as one listed above may be combined with a reactive diluent. In other instances, the solvent may be a reactive diluent. In some embodiments, the reactive diluent may react with a component described herein and may form a part of the coating/resin. Exemplary reactive diluents include (cyclo)aliphatic monoepoxides (e.g., 2-ethylhexyl diglycidyl ether, cyclohexane dimethanol diglycidyl ether), monoglycidyl ethers of fatty alcohols (e.g., stearyl alcohol), unsaturated (cyclo)alkyl monoepoxides (e.g., cyclohexenyl glycidyl ether, allyl glycidyl ether, vinyl glycidyl ether, aryl glycidyl ethers), difunctional aliphatic diglycidyl ethers (e.g., 1,4-butanediol diglycidyl ether, 1,6-hexanediol diglycidyl ether, neopentylglycol diglycidyl ether, dipropylene diglycidyl ether, polypropylene diglycidyl ether), acrylates, methacrylates, glycidyl (meth)acrylate, polyoxyamines, (cyclo)aliphatic amines, mannich bases, low molecular weight diols (e.g., ethylene glycol, propylene glycol), low molecular weight triols (e.g., glycerine), diamines (e.g., ethylene diamine, propylene diamine), dithiols, and combinations thereof.

To form a resin including at least two components, the at least two components may be combined with a predetermined amount of one or more solvents and sufficiently mixed to incorporate each component into the solvent(s). In some instances, incorporating a component into a solvent may involve dissolving the component in the solvent. In other instances, incorporating a component into a solvent may involve forming a suspension of the component in the solvent. A component may also be incorporated into a solvent by forming an emulsion. Other methods of incorporating a component into a solvent are also possible.

Any suitable coating method may be used to form a coating on the main filtration layer, or other layer(s) of the filter media (e.g., pre-filter layer(s)). In some embodiments, as discussed further below, a coating comprising a binder resin may be added to the fiber web (e.g., main filtration layer, pre-filter layer) by a solvent saturation (e.g., by an organic or inorganic solvent) process and/or an aqueous-based (i.e., by a water based solvent) process. In some embodiments, the resin may be applied to a fiber web using a non-compressive coating technique. The non-compressive coating technique may coat the fiber web, while not substantially decreasing the thickness of the web. In other embodiments, the resin may be applied to the fiber web using a compressive coating technique. Non-limiting examples of coating methods include the use of a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating, gapped roll coating, roll transfer coating, padding saturant coating, and saturation impregnation. Other coating methods are also possible.

In some embodiments, the main filtration layer, or other layer(s) of the filter media may be substantially saturated by the coating. For example, the coating may impregnate substantially all or the entirety of the layer(s).

In certain embodiments, a polymeric material can be impregnated into the fiber web either during or after the fiber web is being manufactured on a papermaking machine. For example, during a manufacturing process described herein, after the fiber web is formed and dried, a polymeric material in a water based emulsion or an organic solvent based solution can be adhered to an application roll and then applied to the article under a controlled pressure by using a size press or gravure saturator.

The amount of the polymeric material impregnated into the fiber web typically depends on the viscosity, solids content, and absorption rate of fiber web. As another example, after the fiber web is formed, it can be impregnated with a polymeric material by using a reverse roll applicator following the just-mentioned method and/or by using a dip and squeeze method (e.g., by dipping a dried filter media into a polymer emulsion or solution and then squeezing out the excess polymer by using a nip). A polymeric material can also be applied to the fiber web by other methods known in the art, such as spraying or foaming.

In some embodiments, the binder resin is precipitated on to the fibers. When appropriate, any suitable precipitating agent (e.g., Epichlorohydrin, fluorocarbon) may be provided to the fibers, for example, by injection into a fiber blend. In some embodiments, upon addition to the fiber blend, the binder resin is added in a manner such that the layer is impregnated with the binder resin (e.g., the binder resin permeates throughout the layer). In a multi-layered web, a binder resin may be added to each of the layers or to only some of the layers separately prior to combining the layers, or the binder resin may be added to the layers after combining the layers. In some embodiments, binder resin is added to the fiber blend while in a dry state, for example, by spraying or saturation impregnation, or any of the above methods. In other embodiments, a binder resin is added to a wet layer.

As discussed above, the binder resin may coat any suitable portion of the fiber web. In some embodiments, the coating of resin may be formed such that the surfaces of the fiber web are coated without substantially coating the interior of the fiber web. In some instances, a single surface of the fiber web may be coated (e.g., single side coating). For example, a top surface or layer of the fiber web may be coated.

As an example, a main filtration layer (e.g., meltblown layer) may be formed on a scrim and the coating may be applied from the main filtration layer side or the scrim side. In other instances, more than one surface of the main filtration layer may be coated (e.g., the top and bottom surfaces or layers, dual side coating). In the example above, the coating may be applied to the main filtration layer side and the scrim side simultaneously. In other embodiments, certain portions of the main filtration layer may be coated without substantially coating other portions of the main filtration layer. The coating may also be formed such that at least one surface or portion of the main filtration layer and the interior of the main filtration layer are coated. In some embodiments, the entire web is coated with the resin.

In some embodiments, at least a portion of the fibers of the main filtration layer may be coated without substantially blocking the pores of the main filtration layer. In some instances, substantially all of the fibers may be coated without substantially blocking the pores. In some embodiments, the main filtration layer may be coated with a relatively high weight percentage of resin without blocking the pores of the main filtration layer using the methods described herein (e.g., by dissolving and/or suspending one or more components in a solvent to form the resin). Coating the fibers of the main filtration layer using the resins described herein may add strength and/or flexibility to the main filtration layer, and leaving the pores substantially unblocked may be important for maintaining or improving certain filtration properties such as air permeability. Accordingly, the coating may be applied to the main filtration layer such that the pores are imparted with a desirable level of mechanical support (e.g., not prone to collapse upon mechanical compression or clogging).

In some embodiments, the main filtration layer may include more than one coating (e.g., on different surfaces of the fiber web). In some cases, the same coating method may be utilized to apply more than one coating. For example, the same coating method may be used to form a first coating on a top surface and a second coating on a bottom surface of the fiber web. In other instances, more than one coating method may be used to apply more than one coating. For example, a first coating method (e.g., dip coating) may be used to form a first coating in the interior of the fiber web and a second coating method (e.g., spray coating) may be used to form a second coating on a bottom surface of the fiber web. When more than one coating exists on a fiber web, in some embodiments the coatings may have the same resin composition. In other embodiments, the resin compositions may differ with respect to certain properties (e.g., first component, second component, ratio of components).

After applying the resin to the fiber web, the resin may be dried to remove most or substantially all of the solvent by any suitable method. Non-limiting examples of drying methods include the use of an infrared dryer, hot air oven steam-heated cylinder, or any other suitable types of dryers familiar to those of ordinary skill in the art.

In various embodiments, after being applied to the fiber web, the resin may undergo at least one chemical reaction to form one or more reaction products as described herein. For example, the components in the resin may be involved in a step-growth polymerization, (e.g., condensation), chain-growth polymerization (e.g., free radical, ionic, etc.), or a crosslinking reaction. The chemical reaction may result in covalent bonding between the components. In some embodiments, external energy (e.g., thermal energy, radiant energy) may be applied to the resin on the fiber web to induce a chemical reaction. In other embodiments, at least one reaction product is formed without the application of external energy. In some embodiments, portions of the resin (or components of the resin) may be polymerized prior to applying the resin to the fiber web.

In certain embodiments, at least one reaction product (e.g., a cured network, a copolymer) may be formed by, for example, heating the coated fiber web at a specific temperature for a suitable amount of time. For instance, in some embodiments, a coated fiber web may be heated at a temperature of greater than or equal to about 90° C., greater than or equal to about 100° C., greater than or equal to about 120° C., greater than or equal to about 150° C., greater than or equal to about 180° C., greater than or equal to about 210° C., greater than or equal to about 240° C., or greater than or equal to about 270° C. In some instances, the temperature may be less than or equal to about 300° C., less than or equal to about 265° C., less than or equal to about 235° C., less than or equal to about 210° C., less than or equal to about 175° C., less than or equal to about 145° C., or less than or equal to about 115° C. Combinations of the above-referenced ranges are also possible (e.g., greater than or equal to about 100° C. and less than or equal to about 210° C.). Other values of temperature are also possible.

In some embodiments, the coated fiber web may be heated to a temperature where the coating cures, yet the fiber web does not shrink. That is, the temperature would be high enough to cause the coating to cure within the fiber web, though, the temperature is insufficient to cause shrinkage of the fiber web.

In some embodiments, the main filtration layer, such as a synthetic polymer fiber (e.g., meltblown, electrospun, solvent electrospun, centrifugal spun, spunbond, meltspun, etc.) layer, may be coated (e.g., saturated, impregnated) with a suitable resin and then adhered to a pre-filter (e.g., including glass fibers, meltblown fibers, cellulose fibers, meltspun fibers, electrospun fibers, etc.). In some embodiments, the pre-filter and the main filtration layer are laminated or collated together and then the entire composite including the pre-filter and main filtration layer, is coated (e.g., saturated, impregnated, surface applied) with a suitable resin.

As discussed above, the overall filter media may include a pre-filter, a main filtration layer and one or more support layers. The filter media as a whole may have a variety of desirable properties and characteristics which make it particularly well-suited for hydraulic applications. However, it should be understood that the filter media described herein are not limited to hydraulic applications, and that the media can be used in other applications such as for air filtration or filtration of other liquids and gases.

The filter media, as well as one or more layers of the filter media, can also have varying average fiber diameter, basis weights, pore sizes, thicknesses, permeabilities, dust holding capacities, efficiencies, and pressure drop, depending upon the requirements of a desired application.

The basis weight of the overall filter media (e.g., including pre-filter and main filtration layer) can vary depending on factors such as the strength requirements of a given filtering application, the number of layers in the filter media, the position of the layer (e.g., upstream, downstream, middle), and the materials used to form the layer, as well as the desired level of filter efficiency and permissible levels of resistance or pressure drop. In certain embodiments described herein, increased performance (e.g., lower resistance or pressure drop) is observed when the filter media includes multiple layers having different properties, where each layer has a relatively low basis weight, compared to certain single- or multi-layered media. As a result, some such filter media may also have a lower overall basis weight while achieving high performance characteristics.

For example, the basis weight of the overall filter media (or of two or more layers of the filter media) may range from between about 1 and 600 g/m². In some embodiments, the overall basis weight is less than or equal to about 200 g/m², less than or equal to about 170 g/m², less than or equal to about 150 g/m², less than or equal to about 130 g/m², less than or equal to about 120 g/m², less than or equal to about 110 g/m², less than or equal to about 100 g/m², less than or equal to about 90 g/m², less than or equal to about 80 g/m², less than or equal to about 70 g/m², less than or equal to about 70 g/m², less than or equal to about 60 g/m²; and/or at least about 60 g/m², at least about 70 g/m², at least about 80 g/m², at least about 90 g/m², at least about 100 g/m², at least about 110 g/m², at least about 120 g/m², at least about 130 g/m², at least about 150 g/m², at least about 170 g/m², or at least about 200 g/m². Combinations of the above-referenced limits are possible. The overall filter media may have a basis weight that falls outside of the above noted ranges.

The overall thickness of a filter media may be at least about 1 mil, at least about 10 mils, at least about 25 mils, at least about 50 mils, at least about 100 mils, at least about 150 mils, at least about 200 mils, at least about 250 mils, at least about 300 mils; and/or less than or equal to about 300 mils, less than or equal to about 250 mils, less than or equal to about 200 mils, less than or equal to about 150 mils, less than or equal to about 100 mils, less than or equal to about 50 mils, less than or equal to about 25 mils, or less than or equal to about 10 mils. Combinations of the above ranges are possible (e.g., between about 1 mil and 300 mils, between about 50 mils and about 200 mils).

The filter media may exhibit an air permeability that falls within a suitable range. In some embodiments, the overall permeability of the filter media, may range from, for example, between about 0.5 cubic feet per minute per square foot (cfm/sf) and about 250 cfm/sf. In various embodiments, the overall permeability of the filter media may be at least about 0.5 cfm/sf, at least about 1 cfm/sf, at least about 5 cfm/sf, at least about 10 cfm/sf, at least about 20 cfm/sf, at least about 25 cfm/sf, at least about 30 cfm/sf, at least about 35 cfm/sf, at least about 40 cfm/sf, at least about 45 cfm/sf, at least about 50 cfm/sf, at least about 100 cfm/sf, at least about 150 cfm/sf, at least about 200 cfm/sf, at least about 250 cfm/sf, at least about 300 cfm/sf; and/or less than or equal to about 300 cfm/sf, less than or equal to about 250 cfm/sf, less than or equal to about 200 cfm/sf, less than or equal to about 150 cfm/sf, less than or equal to about 100 cfm/sf, less than or equal to about 50 cfm/sf, less than or equal to about 25 cfm/sf, less than or equal to about 10 cfm/sf, or less than or equal to about 1 cfm/sf.

As noted above, the pressure drop of the overall filter media may be similar to the pressure drop of the main filtration layer. For example, in some embodiments, the pressure drop of the overall filter media may be less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 4.5 kPa, or less than or equal to about 1 kPa. In some instances, the pressure drop of the overall filter media may be greater than or equal to about 0.05 kPa, greater than or equal to about 0.1 kPa, greater than or equal to about 0.5 kPa, greater than or equal to about 1 kPa, greater than or equal to about 5 kPa, greater than or equal to about 10 kPa, greater than or equal to about 20 kPa, greater than or equal to about 30 kPa, greater than or equal to about 40 kPa, or greater than or equal to about 50 kPa. Combinations of the above-referenced ranges are also possible (e.g., greater than or equal to about 0.05 kPa and less than or equal to about 80 kPa, greater than or equal to about 0.1 kPa and less than or equal to about 50 kPa).

Certain filter media can have relatively low resistance ratios or certain ranges of resistance ratios between two layers that provide favorable filtration properties. For instance, the resistance ratio between a second layer, which includes fibers having a small average diameter, and a first layer, which includes fibers having a comparatively larger average diameter, may be relatively low. In some cases, the second layer is downstream of the first layer, such as that shown in FIG. 1. For example, in one particular embodiment, the second layer is a downstream main filtration layer and the first layer is an upstream pre-filter layer. Other combinations are also possible.

The resistance ratio between two layers (e.g., between a second layer and a first layer, between a downstream layer and an upstream layer, between a main filtration layer and a pre-filter layer, or between two main filtration layers, etc.), calculated as the resistance of the layer having a relatively smaller average fiber diameter to the resistance of the layer having a relatively larger average fiber diameter, may be, for example, between 0.5:1 and 15:1, between 1:1 and 10:1, between 1:1 and 7:1, between 1:1 and 5:1, or between 1:1 and 3.5:1. In some cases, the resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, or greater than 1:1. Advantageously, certain ranges of resistance ratios (including low resistance ratios in some embodiments) can result in the filter media having favorable properties such as high dust holding capacity and/or high efficiency, while maintaining a relatively low overall basis weight. Such characteristics can allow the filter media to be used in a variety of applications.

In one particular set of embodiments, the resistance ratio between a main filtration layer and a pre-filter layer adjacent (e.g., directly adjacent) the main filtration layer of a filter media is between 0.5:1 and 7:1, between 1:1 and 5:1, or between 1:1 and 3.5:1. If the filter media includes another main filtration layer, the resistance ratio between the downstream main filtration layer to the upstream main filtration layer may be between 1:1 and 12:1, between 1:1 and 8:1, between 1:1 and 6:1, or between 1:1 and 4:1. Additional layers are also possible.

The resistance of a layer may be normalized against the basis weight of the layer to produce a normalized resistance (e.g., resistance of a layer divided by the basis weight of the layer). In some cases, a normalized resistance ratio between two layers, e.g., a second layer, which includes fibers having a small average diameter, and a first layer, which includes fibers having a relatively larger average diameter, is relatively low.

The normalized resistance ratio between two layers, calculated as the normalized resistance of the layer having a relatively smaller average fiber diameter to the normalized resistance of the layer having a relatively larger average fiber diameter, may be, for example, between 1:1 and 15:1, between 1:1 and 10:1, between 1:1 and 8:1, between 1:1 and 5:1, or between 1:1 and 3:1. In some cases, the normalized resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, or greater than 1:1.

In one particular set of embodiments, the normalized resistance ratio between a main filtration layer and a pre-filter layer adjacent (e.g., directly adjacent) the main filtration layer of a filter media is between 1:1 and 8:1, between 1:1 and 5:1, or between 1:1 and 3:1. If the filter media includes another main filtration layer, the resistance ratio between the downstream main filtration layer to the upstream main filtration layer may be between 1:1 and 10:1, between 1:1 and 8:1, between 1:1 and 6:1, between 1:1 and 4:1, or between 3:1 and 4:1. Additional layers are also possible.

It can be appreciated that the above characteristics may be applicable for filter media where the pre-filter and/or the main filtration includes more than one layer.

As noted above, a clear demarcation of layers may or may not be apparent between various layers of the filter media. Regardless of whether a clear demarcation between layers is present, in some embodiments, the pre-filter, the main filtration layer, and/or the filter media as a whole, may include a gradient (i.e., a change) in one or more properties such as fiber diameter, fiber type, fiber composition, fiber length, level of fibrillation, fiber surface chemistry, particle size, particle surface area, particle composition, pore size, material density, basis weight, solidity, a proportion of a component (e.g., a binder, resin, crosslinker), stiffness, tensile strength, wicking ability, hydrophilicity/hydrophobicity, and conductivity across a portion, or all of, the thickness of the filter media.

One or more layers of the filter media (e.g., pre-filter, one or more layers of the pre-filter, main filtration layer) and/or the filter media as a whole may optionally include a gradient in one or more performance characteristics such as efficiency, dust holding capacity, pressure drop, air permeability, and porosity across the thickness of the layer(s). A gradient in one or more such properties may be present in one or more layers of the filter media between a top surface and a bottom surface thereof. In the portions of the filter media as a whole, or one or more layers of the filter media, where a gradient in the property is not apparent, the property may be substantially constant through that portion of the filter media. As described herein, in some instances a gradient in a property involves different proportions of a component (e.g., a type of fibrillated fiber, a type of non-fibrillated synthetic fiber, an additive, a binder) across the thickness.

In some embodiments, a component may be present at an amount or a concentration that is different than another portion of the filter media, or layers thereof. In other embodiments, a component is present in one portion of the filter media, but is absent in another portion of the filter media. Other configurations are also possible.

Different types and configurations of gradients are possible within one or more layers of a filter media, or the filter media as a whole. In some embodiments, a gradient in one or more properties is gradual (e.g., linear, curvilinear) between a top surface and a bottom surface of the filter media, or one or more layers thereof. For example, the filter media, or layers of the filter media, may have an increasing amount of fibrillated fibers or other synthetic fibers from the top surface to the bottom surface. In another embodiment, a filter media, or layers thereof, may include a step gradient in one more properties across the thickness. In one such embodiment, the transition in the property may occur primarily at an interface between two layers. For example, a filter media, e.g., having a first layer including a first fiber type (e.g., fibers with a first level of fibrillation) and a second layer including a second fiber type (e.g., fibers with a second level of fibrillation), may have an abrupt transition between fiber types across the interface. In other words, each of the layers of the filter media may be relatively distinct. Other types of gradients are also possible.

A filter media, or a portion thereof (e.g., pre-filter or layers thereof), may include any suitable number of layers, e.g., at least 2, 3, 4, 5, 6, 7, 8, or 9 layers depending on the particular application and performance characteristics desired. It should be appreciated that in some embodiments, the layers forming a filter media may be indistinguishable from one another across the thickness. As such, a filter media formed from, for example, multiple layers (e.g., fiber webs) or two fibrillated fiber and synthetic fiber mixtures can also be characterized as having a single layer (or a composite layer) having a gradient in a property (e.g., pore size, permeability, basis weight, etc.) across the filter media, or portion thereof, in some instances.

In certain embodiments, the filter media as a whole, or one or more layers of the filter media, may exhibit a gradient in mean pore size across at least a portion of the thickness of one or more layers of the filter media, or of the filter media as a whole. In some embodiments, a relationship may exist between mean pore size and the thickness of the filter media, such that the gradient in mean pore size may be represented by a mathematical function.

The gradient may be represented by a convex function, such that a measure of the goodness of fit for the convex function is stronger than the goodness of fit for other functions. The convex function that best represents the gradient in mean pore size may be an exponential function fit to four numerical values of the mean pore size determined at different points across at least the portion of the thickness of the filter media, or layer(s) thereof. For various embodiments, the pre-filter, the main filtration layer, the filter media as a whole, and/or layers thereof may include such a gradient. The exponential function has the form:

mean pore size(x)=a*exp(k*x)

wherein x corresponds to a location along the thickness of the portion of the filter media and is the normalized thickness of the portion of the filter media at a certain mean pore size, a is a constant with micron units, and k is a constant. The exponential function may be determined by using a least squares linear regression model to fit four or more (e.g., at least 6, at least 8, at least 10, at least 12, at least 15, at least 20) numerical values of the mean pore size. In some embodiments, x is normalized to have a value greater than or equal to 0 and less than or equal to 1, and k is greater than or equal to 0.1 and less than or equal to 1.75. The exponential function is determined using a least squares linear regression model and the coefficient of determination of the exponential function is greater than or equal to about 0.9. As used herein, the normalized thickness x refers to a dimensionless thickness that corresponds to a location along the thickness of the gradient. A normalized thickness value is calculated based on the thickness of the selected portion of the gradient.

The normalized thickness value for a given depth may be calculated by subtracting the most downstream depth of the selected thickness portion from the given depth and dividing by the thickness of the selected thickness portion of the gradient portion minus the most downstream depth of the selected portion. For example, a selected thickness portion of a gradient portion may range from 2 mm to 6 mm. The thickness of the selected portion is 4 mm. In such cases, the normalized thickness for a mean pore size determined at a depth of 4 mm is 0.5 (i.e., normalized thickness=(4-2)/(6-2)=0.5). In general, the most downstream location of the selected portion of the gradient portion is 0 and the most upstream location of the selected portion of the gradient portion is 1.

In some embodiments, the constant a may be related to certain structural properties of the filter media, or portion(s) thereof. In some instances, a is related to the mean pore size of a downstream location of the selected portion of the gradient (e.g., x=0). For instance, in some embodiments, the value of a may be greater than or equal to about 0.1 microns and less than or equal to about 100 microns, or greater than or equal to about 0.2 microns and less than or equal to about 60 microns. Other values of a are possible.

In some embodiments, the constant k may be related to certain filtration properties of the filter media, or portion(s) thereof. For example, k may relate to the air resistance of the selected portion of the gradient due, in part, to the relationship between air resistance and mean pore size. In certain embodiments, exponential gradients in mean pore size with certain values of k may have enhanced filtration properties (e.g., dust holding capacity) compared to exponential gradients in mean pore size with other values of k. For instance, in some embodiments, enhanced filtration properties may be achieved for values of k greater than or equal to about 0.1 and less than or equal to about 1.5, or greater than or equal to about 0.25 and less than or equal to about 0.75. Other values of k are possible. In some embodiments, enhanced filtration properties may be achieved with an exponential gradient in mean pore size irrespective of the value of k.

In some embodiments, four numerical values are used to fit to an exponential function. The numerical values of mean pore size may be determined at different arbitrary points across at least a portion of the thickness of the gradient. Numerical values of mean pore size may be determined at points within the gradient such that each point corresponds to a different depth. In some embodiments, the portion of the gradient spanned by the points (i.e., selected thickness portion) is across greater than or equal to about 20% (e.g., greater than or equal to about 30%, greater than or equal to about 40%, greater than or equal to about 50%, greater than or equal to about 60%, greater than or equal to about 70%, greater than or equal to about 80%) of the thickness of the gradient portion of the filter media. In some instances, the numerical values of mean pore size may be determined within different layers of a gradient portion comprising two or more layers. For example, each numerical value of mean pore size may be determined such that each point corresponds to a different layer of a gradient portion having four or more layers.

As described herein, the gradient in mean pore size may be represented by a convex function (e.g., exponential function) that has a strong goodness of fit for the distribution in mean pore size with respect to thickness. For example, a regression model (e.g., non-linear, linear least squares) may be used to fit a distribution of mean pore size with respect to thickness in the portion of the filter media having the gradient. The goodness of fit for the convex function (e.g., exponential function) may be relatively strong and/or may be greater than another function (e.g., linear function, concave function) generated using the same regression model.

In embodiments in which a linear least squares regression model is used, the goodness of fit may be determined by the coefficient of determination (R²) that ranges from zero (i.e., no fit) to one (i.e., perfect fit). In some such embodiments, R² for the exponential function fit to four or more numerical values of the mean pore size determined at different points across at least a portion of the thickness of the gradient in mean pore size may be greater than or equal to about 0.7, greater than or equal to about 0.75, greater than or equal to about 0.8, greater than or equal to about 0.85, greater than or equal to about 0.9, greater than or equal to about 0.95, greater than or equal to about 0.97, greater than or equal to about 0.98, or greater than or equal to about 0.99. For instance, in some embodiments, R² for the exponential function fit to four values may be greater than or equal to about 0.9. In some instances, R² for the exponential function fit to six values may be greater than or equal to about 0.85. In certain embodiments, R² for the exponential function fit to ten values may be greater than or equal to about 0.8. In other embodiments, R² for the exponential function fit to 15 or more values may be greater than or equal to about 0.75. The linear least squares regression models may be applied to a function by utilizing linearization methods known to those of ordinary skill in the art.

In certain embodiments, the coefficient of determination (R²) for the convex function (e.g., exponential function) may be greater than other functions generated using the least squares linear regression model. For example, the convex function (e.g., exponential function) may have the greatest coefficient of determination (R²) and may be referred to as the best fit function for the distribution. In some embodiments, the coefficient of determination of the convex function (e.g., exponential function) is greater than all coefficient of determinations for one or more class of functions (e.g., linear, quadratic) fit to the four or more numerical values of the mean pore size using the least squares linear regression model. For instance, the coefficient of determination of the convex function (e.g., exponential function) may be greater than all coefficient of determinations for linear, quadratic, concave, sigmoidal, and/or periodic functions fit to the four or more numerical values of the mean pore size using the least squares linear regression model.

It should be understood that though a filter media, or portion(s) thereof, having a gradient in a property have been described in terms of a gradient in mean pore size, the filter media may have a gradient in another property (e.g., fiber furnish, solidity) instead of, or in addition to, a gradient in mean pore size. For instance, in some embodiments, a filter media, or portion(s) thereof, having an exponential gradient in mean pore size across at least a portion of the thickness may have a gradient in fiber furnish (i.e., the percentage of a fiber type varies) and/or a gradient in solidity.

In some instances, a filter media, or portion(s) thereof, may have a convex gradient (e.g., exponential gradient) in solidity across at least a portion of the thickness, such that the highest numerical value of solidity occurs at the most downstream point of the gradient and the lowest solidity occurs at the most upstream point of the gradient. In certain cases, the filter media, or portion(s) thereof, may have convex gradient (e.g., exponential gradient) in mean fiber diameter across at least a portion of the thickness of the filter media. In general, the filter media, or portion(s) thereof, may have a gradient in any property or combination of properties that are capable of achieving the desired filtration and/or mechanical properties.

As described herein, a filter media, or portion(s) thereof, may have a gradient in mean pore size across at least a portion of the thickness. In some embodiments, the gradient in mean pore size may be across the entire filter media. In some such embodiments, the filter media may be a single layer or have multiple layers that form the gradient. In other embodiments, the gradient in mean pore size may be across a portion of the filter media. In some cases, the portion of the filter media having the gradient in mean pore size may be a portion of a single layer, or at least one layer of, a multi-layered filter media. In some instances, the portion of the filter media having the gradient in mean pore size may be across one or more layers of a multi-layered filter media. For instance, the gradient may be across the thickness of 1, 2, 3, 4, 5, 6, etc. layers of a multi-layered filter media.

In some embodiments, each layer of a multi-layered gradient may have a different mean pore size, such that a convex function (e.g., exponential function) fit to four or more numerical values of mean pore size determined at different layers of the multi-layered gradient has a strong goodness of fit, as described herein. In certain embodiments, at least one layer of a multi-layered gradient may have a constant mean pore size, i.e., the mean pore size does not change across the thickness of the layer. For example, a multi-layered gradient may comprise four layers (e.g., laminated together) that each has a constant mean pore size across the thickness of the layer and each has a different mean pore size than the other layers.

In some embodiments, the magnitude of the change in mean pore size across the filter media, or portion(s) thereof (i.e., mean pore size at the most upstream location minus the most downstream location of the gradient), may vary appropriately. For example, in some applications, the magnitude of the change in mean pore size across the filter media, or portion(s) thereof, may be greater than or equal to about 1 micron and less than or equal to about 60 microns, greater than or equal to about 2 microns and less than or equal to about 30 microns, greater than or equal to about 3 microns and less than or equal to about 60 microns, or greater than or equal to about 0.1 microns and less than or equal to about 5 microns. Other values of the average magnitude of change of the filter media, or portion(s) thereof, in mean pore size are possible.

The overall mean pore size may be determined using X-ray computed tomography for the entire gradient portion or ASTM F-316-80 Method B, BS6410 for the entire portion of the filter media that has a gradient. In some embodiments, the mean pore size of the gradient portion may be measured using X-ray computed tomography (e.g., SkyScan 2011 X-ray nanotomograph scanner manufactured by BRUKER-MICROCT, Kartuizersweg 3B, 2550 Kontich, Belgium).

It can be appreciated that the “mean pore size” and the “mean flow pore size” are measured using different methods, as described herein, where “mean pore size” is a radiation based measurement for cross-sections of material, and the “mean flow pore size” is a flow based measurement for a bulk material.

In general, X-ray computed tomography may be used to produce a 3D computational representation of the filter media, or portion(s) thereof. Computational methods are used to distinguish void spaces (i.e. pores) from solid regions (i.e., fibers) of the filter. Additional computational methods may then be used to determine the average diameter of the void spaces (i.e., mean pore size) of the 3D computational representation of the filter media, or portion(s) thereof. In some instances, the computational method establishes a cut-off value (i.e., threshold value) for distinguishing voids from solid regions to generate the 3D computational representation of the filter media, or portion(s) thereof. In such cases, the accuracy of the cut-off value may be confirmed by comparing the computationally determined air permeability of the 3D computational representation of the filter media to the experimentally determined air permeability of the actual filter media. In embodiments in which the computationally and experimentally determined air permeabilities are substantially different, the threshold value may be changed by the user until the air permeabilities are substantially the same.

For instance, in embodiments in which the diameter of the discrete pores changes across at least a portion of the thickness of the filter media, an X-ray computed tomography (“CT”) machine may scan the filter media and take a plurality of X-ray radiographs at various projection angles through the filter media. Each X-ray radiograph may depict a slice along a plane of the filter media and is converted into a grayscale image of the slice by computational methods known to those of skill in the art (e.g., SkyScan CT-Analyzer software suite manufactured by BRUKER-MICROCT, Kartuizersweg 3B, 2550 Kontich, Belgium). Each slice has a defined thickness such that the grayscale image of the slice is composed of voxels (volume elements), not pixels (picture elements). The plurality of slices generated from the X-ray radiographs may be used to produce a 3D volume rendering of the entire filter media thickness with cross-sectional dimensions of at least 100×100 μm using computational methods as noted above. The resolution (voxel size) of the image may be less than or equal to 0.3 microns.

In some embodiments, the 3D volume rendering of the filter media thickness along with experimental measurements of the permeability of the filter media may be used to determine the mean pore size. Each individual grayscale image generated from the X-ray radiographs typically consists of light intensity data scaled in an 8-bit range (i.e., 0-255 possible values). To form the 3D volume rendering of the filter media thickness, the 8-bit grayscale images are converted into binary images.

The conversion of the 8-bit grayscale images to binary images requires the selection of an appropriate intensity threshold cut-off value to distinguish solid regions of the filter media from pore spaces in the filter media. The intensity threshold cut-off value is applied to the 8-bit grayscale image and is used to correctly segment solid and pore spaces in the binary image. The binary images are then used to create a virtual media domain, i.e., 3D rectangular array of filled (fiber) voxels and void (pore) voxels that accurately identifies solid regions and pore spaces. Various thresholding algorithms are reviewed in: Jain, A. (1989), Fundamentals of digital image processing, Englewood Cliffs, N.J.: Prentice Hall. and Russ. (2002), The image processing handbook, 4th ed. Boca Raton, Fla.: CRC Press.

It can be appreciated that the above description regarding a filter media, or portion(s) thereof, having a gradient in mean pore size may be applicable for other types of filter media where dust holding capacity or other characteristics (e.g., pressure drop, permeability) are enhanced.

The overall filter media (e.g., main filtration layer and pre-filter layer(s) together) may have favorable dust holding properties. For example, the filter media as a whole may have a dust holding capacity of at least about 10 g/m², at least about 15 g/m², at least about 30 g/m², at least about 50 g/m², at least about 70 g/m², at least about 100 g/m², at least about 120 g/m², at least about 140 g/m², at least about 150 g/m², at least about 160 g/m², at least about 180 g/m², at least about 200 g/m², at least about 220 g/m², at least about 240 g/m², at least about 260 g/m², at least about 280 g/m², at least about 300 g/m², at least about 320 g/m², at least about 340 g/m², or at least about 350 g/m². In some embodiments, the overall filter media may have a dust holding capacity of less than about 350 g/m², less than about 300 g/m², less than about 250 g/m², less than about 200 g/m², less than about 150 g/m², less than about 100 g/m², less than about 50 g/m², or less than about 30 g/m². Combinations of the above-noted ranges, or ranges that fall outside of these ranges, are also possible. The dust holding capacity, as referred to herein, is tested based on the above described multipass filter test where the test was run at a face velocity of 0.67 cm/s until a terminal pressure of 500 kPa above the baseline filter pressure across the media is obtained. As previously discussed, the dust holding capacity at 200 kPa was estimated using linear interpolation based on the measurement at 500 kPa. In certain embodiments, the dust holding capacity of the overall filter media may be substantially similar to that of the dust holding capacity of the filtration layer, or the pre-filter layer, of the filter media.

In some embodiments, a filter media described herein may include a relatively high overall dust holding capacity, such as one of the values described above, and a relatively high overall permeability, such as one of the values described above. For instance, a filter media may have an overall dust holding capacity of at least about 150 g/m² (e.g., at least about 180 g/m², at least about 200 g/m², at least about 230 g/m², at least about 250 g/m²), and an overall permeability of greater than about 25 cfm/sf (e.g., greater than about 30 cfm/sf, greater than about 35 cfm/sf, greater than about 40 cfm/sf, greater than about 45 cfm/sf, or greater than about 50 cfm/sf).

In certain embodiments, the main filtration layer, or other layer(s), of a filter media described herein has a mean flow pore size value as described herein and an efficiency of Beta₍ₓ₎=at least 200. In some instances, the main filtration layer has an efficiency of Beta₍ₓ₎=at least 200 and a mean flow pore size of x±2 microns. For example, if x=10 and the main filtration layer has an efficiency of Beta₍₁₀₎=at least 200, the mean pore size of the main filtration layer may be 10±2 microns (i.e., 8-12 microns). In other cases, the main filtration layer has an efficiency of Beta₍ₓ₎=at least 200 and a mean flow pore size of x±1 micron. As noted above, the beta efficiency is measured according to the multipass filter test described above in accordance with ISO 16889. In some embodiments, the efficiency of the overall filter media may be substantially similar to that of the efficiency of the main filtration layer of the filter media. The filter media as a whole may exhibit a wide range of Beta values, e.g., a Beta(x)=y, where x can be, for example, 1, 3, 5, 7, 10, 12, 15, 20, 25, 30, 50, 70, or 100, and where y can be, for example, at least 2, at least 10, at least 75, at least 100, at least 200, or at least 1000. It should be understood that other values of x and y are also possible; for instance, in some cases, y may be greater than 1000. It should also be understood that for any value of x, y may be any number (e.g., 10.2, 12.4) representing the actual ratio of C₀ to C. Likewise, for any value of y, x may be any number representing the minimum particle size that will achieve the actual ratio of C₀ to C that is equal to y.

It may be preferable for the filter media, or one or more layers thereof, to exhibit certain mechanical properties. For instance, filter media described herein may have favorable tensile strength in the cross-machine and machine directions, Mullen burst strength, or other mechanical properties. In some embodiments, certain mechanical properties of the filter media and/or one or more layers thereof, such as tensile strength in the cross-machine and machine directions, or Mullen burst strength, may be enhanced according to the type of coating (e.g., resin) applied thereto.

The tensile strength properties of the filter media may vary appropriately. Tensile strength is measured in accordance with TAPPI T 494 om-01 “Tensile breaking properties of paper and paperboard (using constant rate of elongation apparatus).” In some embodiments, the overall filter media and/or one or more layers (e.g., main filtration layer) of the filter media may have a tensile strength in the machine direction and/or cross-machine direction of greater than about 1.0 lb/inch, greater than about 1.5 lbs/inch, greater than about 2.0 lbs/inch, greater than about 3.0 lbs/inch, greater than about 5.0 lbs/inch, greater than about 10 lbs/inch, greater than about 15 lbs/inch, greater than about 20 lbs/inch, greater than about 25 lbs/inch, greater than about 30 lbs/inch, greater than about 35 lbs/inch, greater than about 40 lbs/inch, greater than about 45 lbs/inch, or greater than 50 lbs/inch. In some embodiments, the overall filter media and/or one or more layers (e.g., main filtration layer) of the filter media may have a tensile strength in the machine direction and/or cross-machine direction of less than about 50.0 lbs/inch, less than about 45.0 lbs/inch, less than about 40.0 lbs/inch, less than about 35.0 lbs/inch, less than about 30.0 lbs/inch, less than about 25.0 lbs/inch, less than about 20.0 lbs/inch, less than about 15.0 lbs/inch, less than about 10.0 lbs/inch, less than about 5.0 lbs/inch, less than about 3.0 lbs/inch, or less than about 1.0 lb/inch. Combinations of the above-noted ranges, or other ranges, are also possible. For example, the filter media may have a tensile strength in the machine direction and/or cross-machine direction between about 1.0 lb/inch and about 50.0 lbs/inch, between about 2.0 lbs/inch and about 50.0 lbs/inch, or between about 3.0 lbs/inch and about 45.0 lbs/inch.

The Mullen burst strength characteristics of the filter media may vary appropriately. Mullen burst strength is measured in accordance with T403 om-91 standard, the DIN 53141 standard. In some embodiments, the overall filter media and/or one or more layers (e.g., main filtration layer) of the filter media may have a Mullen burst strength of greater than about 3 psi, greater than about 5 psi, greater than about 6 psi, greater than about 10 psi, greater than about 20 psi, greater than about 30 psi, greater than about 40 psi, greater than about 50 psi, greater than about 60 psi, greater than about 70 psi, greater than about 80 psi, greater than about 90 psi, greater than about 100 psi. In some embodiments, the overall filter media and/or one or more layers (e.g., main filtration layer) of the filter media may have a Mullen burst strength of less than about 100 psi, less than about 90 psi, less than about 80 psi, less than about 70 psi, less than about 60 psi, less than about 50 psi, less than about 40 psi, less than about 30 psi, less than about 20 psi, less than about 10 psi, less than about 5 psi, or less than about 3 psi. It can be appreciated that combinations of the above-noted ranges, or other ranges, are also possible. For example, the filter media may have a Mullen burst strength between about 3 psi and about 100 psi, between about 5 psi and about 100 psi, or between about 6 psi and about 80 psi.

In various embodiments, a pre-filter comprising one or more layers and one or more main filtration layers may be laminated together. For instance, a first layer (e.g., a pre-filter including relatively coarse fibers, and which may itself include multiple layers) may be laminated with a second layer (e.g., a main filtration layer including relatively fine fibers), where the first and second layers face each other to form a single, multilayer article (e.g., a composite article) that is integrally joined to form the filter media. If desired, the first and second layers can be combined with another main filtration layer (e.g., a third layer) using any suitable process before or after the lamination step. In other embodiments, two or more layers (e.g., main filtration layers) are laminated together to form a multilayer article. After lamination of two or more layers into a composite article, the composite article may be combined with additional layers via any suitable process.

During or after formation of a layer, a composite article including two or more combined layers, or a final filter media, the layer, composite article or final filter media may be further processed according to a variety of known techniques. For example, the filter media or portions thereof may be pleated and used in a pleated filter element. For instance, two layers may be joined by a co-pleating process. In some embodiments, filter media, or various layers thereof, may be suitably pleated by forming score lines at appropriately spaced distances apart from one another, allowing the filter media to be folded. It should be appreciated that any suitable pleating technique may be used. The physical and mechanical qualities of the filter media can be tailored to provide, in some embodiments, an increased number of pleats, which may be directly proportional to increased surface area of the filter media. The increased surface area may allow the filter media to have an increased filtration efficiency of particles from fluids. For example, in some cases, the filter media described herein includes 2-12 pleats per inch, 3-8 pleats per inch, or 2-5 pleats per inch. Other values are also possible.

It should be appreciated that the filter media may include other parts in addition to the two or more layers described herein. In some embodiments, further processing includes incorporation of one or more structural features and/or stiffening elements. For instance, the media may be combined with additional structural features such as polymeric and/or metallic meshes. In one embodiment, a screen backing may be disposed on the filter media, providing for further stiffness. In some cases, a screen backing may aid in retaining the pleated configuration. For example, a screen backing may be an expanded metal wire or an extruded plastic mesh.

As previously indicated, the filter media disclosed herein can be incorporated into a variety of filter elements for use in various applications including hydraulic and non-hydraulic filtration applications. Exemplary uses of hydraulic filters (e.g., high-, medium-, and low-pressure filters) include mobile and industrial filters. Exemplary uses of non-hydraulic filters include fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

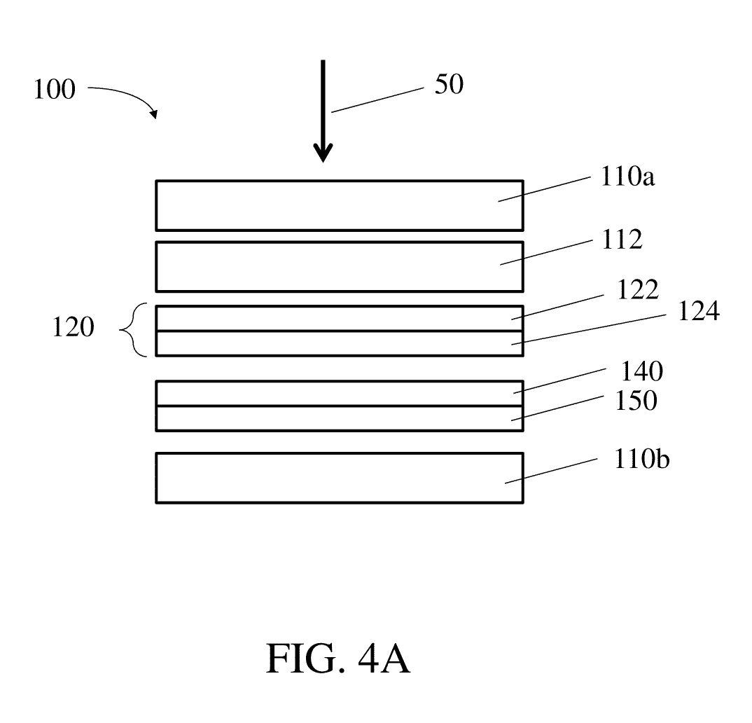

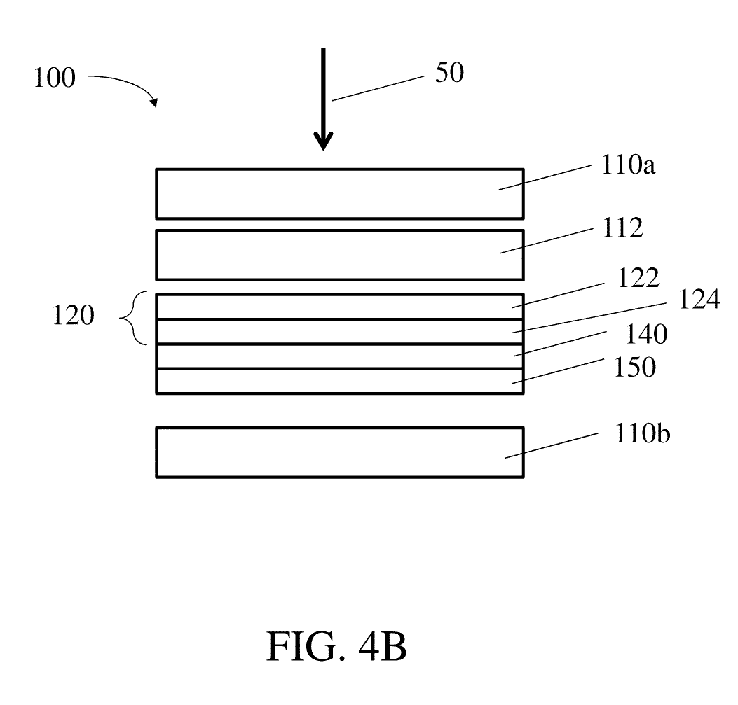

As provided herein, any suitable filter element arrangement may be employed. In some embodiments, various layers may be co-pleated together. For example, FIG. 4A depicts an illustrative embodiment of a filter element 100 where the direction of fluid flow is indicated by arrow 50. Starting from the most upstream layer, the filter media includes a wire mesh 110a, followed by a scrim 112 and then a pre-filter 120.

The pre-filter 120 may have any suitable number of layers, though, in FIG. 4A, the pre-filter is a dual layer pre-filter that includes a first layer 122 and a second layer 124 (e.g., glass fiber webs). In some embodiments, the first layer 122 is formed over the second layer 124 in a wet laid process.

The main filtration layer 140 (e.g., resin saturated meltblown layer), attached to a scrim 150 (e.g., resin saturated scrim), may be located immediately downstream from the pre-filter 120. In this embodiment, the main filtration layer 140 may be formed on the scrim 150 and are co-pleated together. In addition, the main filtration layer 140 and the scrim 150 may be saturated or otherwise coated with a resin together. An additional wire mesh 110b is located on the downstream side of the filter element 100.

FIG. 4B shows another illustrative embodiment of a filter element 100. Similar to that shown in FIG. 4A, a wire mesh 110a and scrim 112 are located upstream the pre-filter and main filtration layer. In this embodiment, the pre-filter 120 is also a dual layer pre-filter that includes a first layer 122 and a second layer 124 (e.g., glass fiber webs). The pre-filter is attached to the main filtration layer 140 (e.g., resin saturated meltblown layer), which is attached to a scrim 150 (e.g., resin saturated scrim). The pre-filter itself is optionally saturated along with the main filtration layer 140 and scrim 150. Here, the pre-filter 120, the main filtration layer 140 and the scrim 150 are co-pleated together. An additional wire mesh 110b is located on the downstream side of the filter element 100.

In some embodiments, one or more layers of the filter media may be provided in a wrapped configuration. For example, the main filtration layer (e.g., meltblown layer), or other layers of the filter media, may be wrapped around a central core (e.g., conduit through which fluid flows). Or, the main filtration layer may be wrapped around one or more pleated glass layers. While for some embodiments, one or more layers of the filter media are pleated, in other embodiments, certain layers of the filter media are not pleated. Support layers, such as meshes and/or scrims may also be pleated and/or wrapped around certain layers of the filter media. For example, such support layers may be wrapped around a filter media including a meltblown-glass composite.

In one set of embodiments, the filter media described herein is incorporated into a filter element having a cylindrical configuration, which may be suitable for hydraulic and other applications. The cylindrical filter element may include a steel support mesh that can provide pleat support and spacing, and which protects against media damage during handling and/or installation. The steel support mesh may be positioned as an upstream and/or downstream layer. The filter element can also include upstream and/or downstream support layers that can protect the filter media during pressure surges.

These layers can be combined with filter media 10, which may include two or more layers as noted above. The filter element may also have any suitable dimensions.

The filter elements may have the same property values as those noted above in connection with the filter media. For example, the above-noted resistance ratios, basis weight ratios, dust holding capacities, efficiencies, specific capacities, and fiber diameter ratios between various layers of the filter media may also be found in filter elements.

During use, the filter media mechanically trap particles on or in the layers as fluid flows through the filter media. The filter media need not be electrically charged to enhance trapping of contamination. Thus, in some embodiments, the filter media are not electrically charged. However, in some embodiments, the filter media may be electrically charged.

### EXAMPLES

The following examples are intended to illustrate certain embodiments of the present invention, but are not to be construed as limiting and do not exemplify the full scope of the invention.

### Example 1

### Unsaturated Glass Pre-Filter and Solvent-Based Saturated Meltblown Filtration Layer with Scrim

The filter media of Example 1 includes a dual layer glass pre-filter and a meltblown main filtration layer formed on to a polyester scrim. In this example, the meltblown main filtration layer is formed on to the scrim, the scrim being on the downstream side. The combined meltblown main filtration layer and scrim were saturated together with a solvent-based resin. The dual layer glass pre-filter was formed separately from the meltblown main filtration layer and scrim and adhered thereon, on the upstream side.

The meltblown main filtration layer was formed on a belt and laminated on to a scrim. The meltblown main filtration layer and scrim were then saturated with an epoxy-type resin including a reactive amide curing agent using a roll transfer coating system, as also described further above. The resin has a 4% solids content, and includes 3.9 wt. % bisphenol-A epoxy resin, 4.1 wt. % curing agent, 14 wt. % acetone and 78% wt. % methanol.

During saturation, the gap distance during roll transfer coating was maintained to be about 80% or greater of the thickness of the meltblown main filtration layer, to maintain a desirable amount of clearance, while also clearing excess resin that may otherwise be deposited on the surface of the meltblown main filtration layer.

Upon saturation, the meltblown main filtration layer and scrim were heated in a first oven to evaporate excess solvent therefrom. The meltblown main filtration layer and scrim were heated in a second oven to cure the resin.

After curing, the basis weight, mean flow pore size and air permeability of the meltblown main filtration layer and scrim sheet were measured, using techniques described above. Table 1 provides a listing of various conditions (i.e., gap distance between roll coater and the meltblown main filtration layer, weight percentage of resin content of the meltblown main filtration layer, cure temperature of the resin) under which the meltblown main filtration layer was formed as well as physical properties of the meltblown main filtration layer with scrim laminated thereto (i.e., basis weight, air permeability, mean flow pore size).

TABLE 1
Physical properties for Saturated Meltblown
main Filtration layer and scrim

| Saturated | | | | | | |
|---|---|---|---|---|---|---|
| Meltblown | | | | | | |
| Main | Gap | | Cure | | Air | Mean |
| Filtration | Dis- | Resin | Temper- | Basis | Perme- | Flow |
| Layer with | tance | Content | ature | Weight | ability | Pore Size |
| Scrim | (%) | (%) | (° C.) | (gsm) | (cfm) | (microns) |
| 1 | 87 | 10-15 | 80 | 39 | 72 | 9.5 |
| 2 | 100 | 10-15 | 80 | 37 | 70 | 9.99 |
| 3 | 87 | 10-15 | 80 | 39 | 66 | 8.92 |
| 4 | 87 | 10-15 | 80 | 40 | 57 | 10.9 |
| 5 | 87 | 15-20 | 80 | 42 | 57 | 9.0 |
| 6 | 87 | 15-20 | 80 | 43 | 51 | 8.77 |
| 7 | 87 | 15-20 | 80 | 43 | 53 | 8.8 |
| 8 | 87 | 5-10 | 80 | 40 | 78 | 8.5 |
| 9 | 87 | 5-10 | 80 | 40 | 74 | 8.2 |
| 10 | 87 | 5-10 | 100 | 38 | 66 | 7.73 |
| 11 | 87 | 15 | 100 | 40 | 55 | 8.7 |

The dual layer glass pre-filter was fabricated using a wet laid papermaking process involving a fourdrinier machine, and includes a first layer and a second layer formed on top of the first layer. Here, the first layer was formed to be tighter (lower permeability) than the second layer. Accordingly, in this example, during a filtration test where air is passed through the pre-filter, the first layer is the downstream layer and the second layer is the upstream layer.

In forming the first layer, a slurry, composed of microglass fibers, chopped strand fibers, polyester staple fibers, polyvinyl alcohol binder fibers in sulfuric acid and water, was made up in a primary headbox using the relative percentages provided below in Table 2. The slurry was flowed onto a forming wire and drained by gravity and vacuum slots, resulting in formation of the first layer on the wire.

In forming the second layer, a slurry, composed of microglass fibers, chopped strand fibers, polyester staple fibers, polyvinyl alcohol binder fibers in sulfuric acid and water, was made up in a secondary headbox using the relative percentages provided below in Table 2. The secondary headbox was positioned so that the forming wire carrying the first layer passed underneath the secondary headbox. The slurry from the secondary headbox was laid on top of and drained through the formed first layer. Additional water was removed by vacuum slots, resulting in a dual layer glass web. Additional microglass fibers were added to the first layer in an auxiliary flow to reach a permeability of approximately 85 cfm/sf.

The dual layer glass fiber web was then sprayed with an acrylic latex resin and subsequently dried by a series of steam filled dryer cans. The total basis weight of the sheet was measured to be 85 gsm.

TABLE 2
Composition of Glass Pre-filter

| | First Layer | Second Layer |
|---|---|---|
| Component | (wt. %) | (wt. %) |
| Microglass fibers | 28.4% | — |
| (1.9 micron diameter) | | |
| Microglass fibers | 45.4% | 55.5% |
| (5.8 microns diameter) | | |
| Chopped strand fibers | 11.3% | 30.9% |
| (6.5 microns diameter, 0.25 inch length) | | |
| Polyester staple fibers | 13.7% | 12.2% |
| (9 microns diameter, 5 mm length) | | |
| Polyvinyl alcohol binder fibers | 1.2% | 1.4% |

The dual layer glass pre-filter was then collated on to the saturated meltblown main filtration layer and scrim. In this configuration, the dual layer glass pre-filter was positioned upstream from the saturated meltblown main filtration layer and scrim, the scrim being positioned on the downstream side with respect to the meltblown main filtration layer.

A number of properties for the dual layer glass pre-filter combined with the saturated meltblown main filtration layer and scrim were then measured and recorded in Table 3. As recorded, the mean flow pore size, beta 200 efficiency, dust holding capacity, pressure drop and air permeability were observed to be within preferred ranges.

TABLE 3
Properties for Unsaturated Glass Pre-Filter and Saturated
Meltblown Main Filtration layer with Scrim

| | | | Dust | | |
|---|---|---|---|---|---|
| Unsaturated Glass | | | holding | | |
| Pre-Filter and | Mean | | capacity | Pres- | Air |
| Saturated Meltblown | flow | Beta 200 | at 200 | sure | perme- |
| Main Filtration | pore size | efficiency | kPa | drop | ability |
| Layer with Scrim | (microns) | (microns) | (gsm) | (kPa) | (cfm/sf) |
| 1 | 124 | 10.1 | 160 | 2.06 | 39 |
| 2 | 122 | 9.6 | 150 | 2.05 | 38 |
| 3 | 124 | 10.2 | 183 | 2.24 | 37 |
| 4 | 125 | 9.3 | 202 | 2.2 | 34 |
| 5 | 127 | 9.7 | 132 | 2.25 | 34 |
| 6 | 128 | 10.1 | 130 | 2.3 | 32 |
| 7 | 128 | 9.5 | 185 | 2.53 | 33 |
| 8 | 125 | 10.2 | 170 | 1.99 | 41 |
| 9 | 125 | 10.6 | 165 | 2.13 | 40 |
| 10 | 123 | 10.5 | 144 | 2.09 | 37 |
| 11 | 125 | 11.5 | 154 | 2.08 | 33 |

### Example 2

### Unsaturated Glass Pre-Filter and Water-Based Saturated Meltblown Main Filtration Layer with Scrim

The filter media of Example 2 includes a dual layer glass pre-filter and a meltblown main filtration layer formed on to a polyester scrim. The dual layer glass pre-filter was formed separately from the meltblown main filtration layer and scrim, in a manner similar to that described above for Example 1. The meltblown main filtration layer was formed on to the scrim, the scrim being on the downstream side, however, rather than being saturated with a solvent-based resin, the combined meltblown main filtration layer and scrim in Example 2 were saturated together with an aqueous-based resin.

The meltblown main filtration layer and scrim were dip saturated in an acrylic resin, prepared as a 1.0 wt. % aqueous solution with 0.5 wt. % sodium oleate surfactant. The excess resin was removed by vacuum and then the meltblown main filtration layer and scrim combination were allowed to dry. The final resin content of the sheet (meltblown main filtration layer and scrim) was approximately 10.0 wt. %. The mean flow pore size of the saturated meltblown main filtration layer and scrim, without the glass pre-filter, was measured to be 9.1 microns.

The dual layer glass pre-filter was then collated on to the saturated meltblown main filtration layer and scrim where the dual layer glass pre-filter was positioned upstream from the saturated meltblown main filtration layer and scrim, and the scrim was positioned on the downstream side with respect to the meltblown main filtration layer.

A number of properties for the dual layer glass pre-filter combined with the saturated meltblown main filtration layer and scrim were then measured to be within preferred ranges. The beta 200 efficiency was measured to be 10.4 microns, the dust holding capacity was measured to be 120 gsm and the pressure drop was measured to be 2.8 kPa.

### Example 3

### Solvent-Based Saturated Glass Pre-Filter and Solvent-Based Saturated Meltblown Main Filtration Layer with Scrim

The filter media of Example 3 includes a dual layer glass pre-filter and a meltblown main filtration layer formed on to a polyester scrim where the dual layer glass pre-filter, meltblown main filtration layer and scrim were saturated together with a solvent-based resin.

The dual layer glass pre-filter and the meltblown main filtration layer with scrim were formed in a manner similar to that described for Example 1. However, prior to saturation, the dual layer glass pre-filter was laminated on to the upstream side of the meltblown main filtration layer and scrim to form a laminated composite. The laminated composite was then pleated using a blade pleater to 0.5 inches in height for 40 pleats for a total area of 146 square inches.

The pleated laminated composite was then dipped in a mixture of 3 wt. % epoxy resin in acetone (2.2 wt. % liquid bisphenol-A epoxy resin; 0.8 wt. % aliphatic amine adduct; and 97 wt. % acetone), and then allowed to dry.

The saturated pleated composite was then tested for pressure drop, according to the methods described above. The pressure drop of the saturated pleated composite was measured to be 3.0 kPa at 12 lpm. This is in contrast to the pressure drop of an unsaturated version of the pleated composition, which was measured to be 5.5 kPa at 12 lpm, and the pressure drop of a conventional 10 micron dual glass filter media (absent meltblown fibers), which was measured to be 4.9 kPa at 12 lpm. Here, the pressure drop of the saturated composite was found to improve by about 38% in comparison to the unsaturated version, and improve by about 35% in comparison to the glass media.

### Example 4

### Solvent-Based Saturated Meltblown Pre-Filter and Solvent-Based Saturated Meltblown Main Filtration Layer with Scrim

The filter media of Example 4 includes a dual layer meltblown pre-filter and a meltblown main filtration layer formed on to a polyester scrim. Here, the pre-filter and filtration layers were made up of synthetic fibers, i.e., meltblown fibers, without the presence of glass fibers. The dual layer meltblown pre-filter, meltblown main filtration layer and scrim were formed and then the layers were saturated together with a solvent-based resin.

The meltblown main filtration layer was formed on a scrim in a manner similar to that discussed above in the other examples. The basis weight of the meltblown main filtration layer and scrim was measured to be 40 gsm and the air permeability was measured to be 65 cfm.

The dual layer meltblown pre-filter was formed on the meltblown main filtration layer. A first meltblown pre-filter layer is formed on the meltblown main filtration layer and a second meltblown pre-filter layer is formed on the first meltblown pre-filter layer. Further, a carded pre-filter layer, used primarily as a backer for structural support, is formed and then laminated on to the second meltblown pre-filter layer.

The basis weight of the first meltblown pre-filter layer, positioned downstream of the second meltblown pre-filter layer and upstream of the meltblown main filtration layer, was measured to be 26 gsm and the air permeability was measured to be 160 cfm.

The basis weight of the second meltblown pre-filter layer, positioned upstream of both the first meltblown pre-filter layer and the meltblown main filtration layer, was measured to be 27 gsm and the air permeability was measured to be 255 cfm.

The basis weight of the carded pre-filter layer, positioned upstream of the first meltblown pre-filter layer, the second meltblown pre-filter layer and the meltblown main filtration layer, was measured to be 90 gsm and the air permeability was measured to be 700 cfm.

The composite including the meltblown pre-filter and the meltblown main filtration layer with scrim was saturated with the epoxy resin with aliphatic amine adduct crosslinker by dipping, similar to Example 3, using roll transfer coating, and then dried.

A number of properties for the saturated meltblown pre-filter and meltblown main filtration layer with scrim were then measured and recorded in Table 4. As recorded, the basis weight, beta 200 efficiency, dust holding capacity, pressure drop and air permeability were observed to be within preferred ranges.

TABLE 4
Properties for Solvent-Based Saturated Meltblown Pre-Filter and
Saturated Meltblown Main Filtration Layer with Scrim Combination

| Solvent-based | | | Dust | | |
|---|---|---|---|---|---|
| Saturated Meltblown | | | holding | | |
| Pre-filter and | | | capacity | Pres- | Air |
| Saturated Meltblown | Basis | Beta 200 | at 200 | sure | perme- |
| Main Filtration | Weight | efficiency | kPa | drop | ability |
| Layer with Scrim | (gsm) | (microns) | (gsm) | (kPa) | (cfm/sf) |
| 1 | 214 | 11.2 | 122 | 1.95 | 35.1 |
| 2 | 216 | 11.5 | 118 | 1.99 | 35.8 |

### Example 5

### Unsaturated Meltblown Pre-Filter and Solvent-Based Saturated Meltblown Main Filtration Layer with Scrim

The filter media of Example 5 includes a dual layer meltblown pre-filter and a meltblown main filtration layer formed on to a polyester scrim. Similar to Example 4 the pre-filter and filtration layers were made up of synthetic fibers. Though, here, the meltblown main filtration layer and scrim were saturated together with a solvent-based resin while the dual layer meltblown pre-filter remained free of the resin.

The dual layer meltblown pre-filter and the meltblown main filtration layer with scrim were formed similar to that described in Example 4. Except before forming the dual layer meltblown pre-filter over the meltblown main filtration layer, the meltblown main filtration layer with scrim were saturated with the epoxy resin with aliphatic amine adduct crosslinker by dipping, using roll transfer coating, and then dried.

A number of properties for the meltblown pre-filter and saturated meltblown main filtration layer with scrim combination were then measured and recorded in Table 5. As recorded, the basis weight, beta 200 efficiency, dust holding capacity, pressure drop and air permeability were observed to be within preferred ranges.

TABLE 5
Properties for Unsaturated Meltblown Pre-Filter and Solvent-
Based Saturated Meltblown Main Filtration Layer with Scrim

| Unsaturated Meltblown | | | Dust | | |
|---|---|---|---|---|---|
| Pre-Filter and | | | holding | | |
| Solvent-based | | | capacity | Pres- | Air |
| Saturated Meltblown | Basis | Beta 200 | at 200 | sure | perme- |
| Main Filtration | Weight | efficiency | kPa | drop | ability |
| Layer with Scrim | (gsm) | (microns) | (gsm) | (kPa) | (cfm/sf) |
| 1 | 199 | 12.0 | 109 | 1.83 | 38.4 |
| 2 | 204 | 11.7 | 102 | 2.10 | 35.4 |

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media comprising:
a first layer including fibers having a first average diameter of between about 0.3 microns and about 40.0 microns;
a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and
a resin coating that coats a majority of an outer surface of the second layer,
wherein the filter media has an air permeability of between about 0.5 cfm/sf and about 500 cfm/sf, a basis weight of between about 1 g/m² and about 600 g/m² and a thickness of between about 1 mils and about 300 mils.

2. The filter media of claim 1, wherein the second average diameter of the synthetic polymer fibers is less than about 5 microns.

3. The filter media of claim 1, wherein the synthetic polymer fibers include meltblown fibers.

4. The filter media of claim 1, wherein a weight percentage of the coating within the second layer is between about 2% and about 60%.

5. (canceled)

6. The filter media of claim 1, wherein the coating substantially saturates the second layer.

7. The filter media of claim 1, wherein the coating coats at least a portion of the first layer.

8-11. (canceled)

12. The filter media of claim 1, wherein the first layer comprises at least one of glass fibers, meltblown fibers, fibrillated fibers, melt spun fibers, electrospun fibers, cellulose fibers and centrifugal spun fibers.

13. The filter media of claim 1, further comprising a third layer positioned between the first layer and the second layer, the third layer including fibers having a third average diameter of between about 1 micron and about 40.0 microns, wherein the third average diameter is greater than the second average diameter.

14. The filter media of claim 13, wherein the first average diameter is greater than the third average diameter.

15. The filter media of claim 13, wherein at least one of the first and third layers comprises at least about 80 wt % glass fibers.

16. (canceled)

17. The filter media of claim 1, wherein the resin coats greater than 75% of the area of the outer surface of the second layer.

18. (canceled)

19. The filter media of claim 1, wherein the second layer has a pressure drop of less than about 80 kPa.

20. The filter media of claim 1, wherein the second layer has a mean flow pore size of between about 0.05 microns and about 30 microns.

21. The filter media of claim 20, wherein the standard deviation of the mean flow pore size of the second layer is less than about 10 microns.

22. The filter media of claim 20, wherein the standard deviation of the mean flow pore size of the coated portion of the second layer is less than about 10 microns.

23. The filter media of claim 1, wherein the coating has a cure temperature that is less than the shrinkage temperature of the synthetic polymer fibers.

24. A hydraulic filter element comprising the filter media of claim 1.

25-26. (canceled)

27. A filter media comprising:
a first layer including fibers having a first average diameter of between about 0.3 microns and about 40.0 microns;
a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and
a resin coating that coats at least a 5 cm×5 cm area of an outer surface of the second layer,
wherein the filter media has an air permeability of between about 0.5 cfm/sf and about 500 cfm/sf, a basis weight of between about 1 g/m² and about 600 g/m² and a thickness of between about 1 mils and about 300 mils.

28-49. (canceled)

50. A filter media comprising:
a first layer including fibers having a first average diameter of between about 0.3 microns and about 40.0 microns;
a second layer adjacent to the first layer, the second layer including synthetic polymer fibers having a second average diameter of between about 0.05 microns and about 15.0 microns and an average fiber length of at least about 5 cm, wherein the first average diameter is greater than the second average diameter; and
a resin coating that coats at least a portion of the second layer, the coating having a cure temperature that is less than a shrinkage temperature of the synthetic polymer fibers,
wherein the filter media has an air permeability of between about 0.5 cfm/sf and about 500 cfm/sf, a basis weight of between about 1 g/m² and about 600 g/m² and a thickness of between about 1 mil and about 300 mils.

51. The filter media of claim 23, wherein the shrinkage temperature of the synthetic polymer fibers is between about 40 degrees C. and about 300 degrees C.

52. The filter media of claim 23, wherein the shrinkage temperature of the synthetic polymer fibers is at least 10% greater than the cure temperature of the synthetic polymer fibers.

53-83. (canceled)
